(19) United States
(12) Patent Application Publication
(10) Pub. No.: US 2008/0244592 A1
(43) Pub. Date: Oct. 2, 2008

(54) MULTITASK PROCESSING DEVICE AND METHOD

(75) Inventor: Naoshi Uchihira, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/055,860

(22) Filed: Mar. 26, 2008

(30) Foreign Application Priority Data
Mar. 27, 2007 (JP) 2007-81241
Feb. 29, 2008 (JP) 2008-50848

(51) Int. Cl. G06F 9/46

(52) U.S. Cl. 718/103; 718/107

(57) ABSTRACT

There is provided with a multitask processing device for processing a plurality of tasks by multitask, the tasks being each split into at least two sections, including: a stable set storage configured to store a stable set including one or more section combinations; a program execution state calculator configured to calculate, for each of the tasks, a program execution state including a section where execution is to start when the task is next executed and current sections of other tasks different from the task among the tasks; a distance calculating unit configured to calculate a distance between each of the program execution states and the stable set; and a task execution unit configured to select and execute a next task to be executed next based on calculated distances.

### CROSS REFERENCE TO RELATED APPLICATIONS

This application is based upon and claims the benefit of priority from the prior Japanese Patent Applications No. 2007-81241, filed on Mar. 27, 2007 and No. 2008-50848, filed on Feb. 29, 2008; the entire contents of which are incorporated herein by reference.

### BACKGROUND OF THE INVENTION

1. Field of the Invention

The present invention relates to a multitask processing device and method, and to an improvement to technology for supporting program development and implementation for information processing devices such as computers. More specifically, the present invention relates to a technology for developing highly reliable programs with a stable performance.

2. Related Art

To develop a computer program, a dedicated program development support device is used to produce the program source code and carry out testing, debugging, and the like. This type of program development support device has various specialized features including an editor and a simulator for execution testing, and may be called a CASE tool, or the like.

Computer programs by nature controls computer operations according to circumstances, and therefore input changes cause operations to change according to the content of the program. However, some of these days programs show a diverse range of operations beyond a range of behavior what was originally designed (expected range). This type of program, with non-determinate behaviors when executed, is known as a nondeterministic program. On the other hand, another type of program, which produces an unique behavior with a fixed input as described above, is known as deterministic program.

A concurrent program is a good example of a non-deterministic program. In concurrent programs a plurality of processes are cooperating while running separately. Overall operation therefore varies depending on which part each process is executed with which timing. Concurrent programs include programs for multitasking systems in which a plurality of tasks are conceptually performed in parallel on a single CPU (known as multithread or multi-process systems) and programs for parallel multitasking systems in which a plurality of CPUs are physically separate and operating in parallel. Moreover, some programs that do not have parallel components are, in reality, non-deterministic due to a non-determined execution sequence caused by variations in the timing of external inputs and the like. For instance, in programs such as sequence control programs for controlling plant (Ladder, SFC), and IF-THEN type programs, though there is no concept of task, rule execution sequence sometimes changes with input timing from the outside. Such programs are nondeterministic.

In program development, testing and debugging nondeterministic programs such as concurrent programs are, as reported by C. E. McDowell and D. P. Helmbold in Debugging Concurrent Programs (ACM Computing Surveys, Vol. 21, No. 4, 1989), much more difficult than in deterministic programs. This is because, when conventional testing and debugging methods are applied to a non-deterministic program, the nondeterministic behavior causes problems such as: (1) an extremely large number of required test cases due to possible combinations of timing conditions; and (2) lack of reproducibility in bug occurrences. The conventional approaches taken to solve these problems can be divided into the following three types:
(1) program testing techniques (Debugging for concurrent programming, and the like)
(2) program verification techniques (Concurrent program verification by formal methods, and the like),
(3) program synthesis techniques (automatic program generation formal specification, and the like).

However, these approaches are associated with problems, including:
(1) a high degree of dependence on the skills of individual users,
(2) only being applicable to simple and limited programs

Moreover, when the program is executed in the real world, the execution environment may differ in terms of machine performance, input timing, implementation and the like. Thus, even after what is though to be sufficient testing has been performed, non-determinate behavior not seen in testing often causes bugs to appear. In systems requiring a high degree of reliability, such as online banking systems, this type of bug is sometimes catastrophic.

Moreover, bugs other than functional bugs sometimes occur. Power consumption and memory usage may exceed an expected range in an unintended and non-deterministic behavior, causing system problems.

In order to solve these problems the present applicant proposes hyper-sequential programming as a technology for developing highly reliable concurrent programs (JP-A H8-16429, Japanese Patent No. 3675623, Japanese Patent No. 3641090, Japanese Patent No. 3278588, U.S. Pat. No. 6,598,222, U.S. Pat. No. 6,275,980, U.S. Pat. No. 5,956,511, U.S. Pat. No. 6,067,415, U.S. Pat. No. 5,860,009). With this technology, a concurrent program is temporarily changed into a sequential program, testing and debugging takes place with the sequential program, and only correct execution logs are merged. The concurrent program is then synthesized from a global state transition system from which any but correct behavior has been removed.

However, with this technology, it is necessary to deal with a state transition model whose size reflects the scale of the program. For these reasons, when the concurrent program is scaled up, the total amount of processing becomes large, and effective application becomes difficult.

The present applicant further proposes a programming support device that makes use of scenarios. With this technology, execution sequences for sections included in a process are expressed as scenarios in a state transition system. The scenarios take the form of a network having nodes connected by edges, with the nodes denoting states and the edges denoting program execution between nodes. Usually a plurality of edges extends from a given edge. If a user then removes inappropriate edges at branches in the scenario, edges denoting appropriate execution sequences remain. Embedding synchronizing commands for realizing the appropriate order in each process allows the user to realize an acceptable execution sequence.

However, this technology has a problem similar to that described above. An entire concurrent program, with a plurality of processes, must be represented using a state transition diagram. Therefore, when a concurrent program is complex, the user has to deal with a proportionally complex state transition system. Furthermore, the synchronizing commands embedded in the program increase program volume, and increase program complexity, making the program difficult to understand. Also, when synchronizing commands are embedded in the program in this way, original synchronizing commands that have existed in the program since the programming (coding) stage, and the above-described newly embedded synchronizing commands for realizing the execution sequence can affect each other. To avoid this, extra care must be taken when coding to avoid this effect.

Previous hyper-sequential programming inventions have also proposed a scheduler for prioritizing the execution of the tasks that indicated the behaviors included in the execution history (log). In the sense that the behaviors included in the log are a record of past and tested behaviors, the set of tested behaviors are a practical example of a “stable set” seen in the present invention. However, with this technology, the judgment was as to whether a certain behavior was included in the stable set, and there was no concept of distance from the stable set. In practice, the stable set was small, and the technology largely failed to work when many behaviors were not in the stable set.

The applicant further proposes an invention in which hyper-sequential programming is applied to programming for interrupt processing. With this technology, a program using interrupt processing is tested by temporarily specifying candidate points at which interrupts will be permitted, and then running execution tests. When the user observes correct execution results, interrupt permission commands are added both at the candidate points that assure the correct result and at surrounding points within a safe range of the candidate points.

However, this technology is troublesome in that the candidate points at which interrupt is to be permitted must be specified in advance. Specifying candidate points is a particular problem in complex cases with a plurality of overlapping interrupts.

### SUMMARY OF THE INVENTION

According to an aspect of the present invention, there is provided with a multitask processing device for processing a plurality of tasks, each task being split into at least two sections, comprising:

a stable set storage configured to store a stable set including one or more section combinations;

a program execution state calculator configured to calculate, for each selected task selected from the tasks, respectively, a program execution state including
a section of the selected task where execution is to start when the selected task is next executed and
current sections of other tasks different from the selected task among the tasks;

a distance calculating unit configured to calculate distances between the program execution states and the stable set; and

a task execution unit configured to select and execute a next task to be executed next based on calculated distances.

According to an aspect of the present invention, there is provided with a multitask processing device for processing a plurality of tasks, each task being split into at least two sections, comprising:

a stable set storage configured to store a stable set having at least one section sequence which includes N sections being successive (where N is an integer greater than or equal to two);

a section calculating unit configured to calculate, for each of the tasks, a section where execution is to start when the task is next executed;

a distance calculating unit configured to calculate, for each of the tasks, a distance between
a section sequence that includes a section calculated by the section calculating unit and N-1 sections that were executed immediately before and
the stable set; and

a task execution unit configured to select and execute a next task to be executed next based on calculated distances.

According to an aspect of the present invention, there is provided with a multitask processing device for processing a plurality of tasks, each task being split into at least two sections, comprising:

a stable set storage configured to store a stable set having at least one set of one or more task and a section;

a section calculating unit configured to calculate, for each of executable tasks in an execution-ready waiting state among the tasks, a section where execution is to start when the executable task is next executed;

a distance calculating unit configured to calculate, for each of the executable tasks, a distance between
a set of the executable tasks and the section calculated by the section calculating unit and
the stable set; and

a task execution unit configured to select and execute a next task to be executed next among the executable tasks based on calculated distances.

According to an aspect of the present invention, there is provided with a multitask processing device for processing a plurality of tasks, each task being split into at least two sections, comprising:

a storage configured to store section characteristic values corresponding to sections;

a program execution state calculator configured to calculate, for each selected task selected from the tasks, respectively, a program execution state including
a section of the selected task where execution is to start when the selected task is next executed and
current sections of other tasks different from the selected task among the tasks; and

a task execution unit configured to select and execute a next task to be executed next based on the section characteristic values of the sections included in each program execution state.

According to an aspect of the present invention, there is provided with a multitask processing device for processing a plurality of tasks, each task being split into at least two sections, comprising:

a stable set storage configured to store a stable set that includes one or more sets each including a section combination and a state of a shared resource;

a program execution state calculator configured to
calculate, for each selected task selected from the tasks, respectively, a program execution state including
   a section of the selected task where execution is to start when the selected task is next executed and
   current sections of other tasks different from the selected task among the tasks and
specify a state of a shared resource used at each calculated program execution state, respectively;

a distance calculating unit configured to calculate a distance between a set including the calculated program execution state and the state of the shared resource corresponding to the calculated program execution state and the stable set, for each calculated program execution state, respectively; and

a task execution unit configured to select and execute a next task to be executed next based on calculated distances.

According to an aspect of the present invention, there is provided with a multitask processing device for processing a plurality of tasks, each task being split into at least two sections, comprising:

a stable set storage configured to store a stable set that includes one or more sets each including a section and a state of at least one of shared resource;

a program execution state calculator configured to
calculate, for each selected task selected from the tasks, respectively, a program execution state including
   a section of the selected task where execution is to start when the selected task is next executed and
   current sections of other tasks different from the selected task among the tasks and
specify a state of at least one of shared resource used at each calculated program execution state, respectively
combine each section of the calculated program execution state with a specified state corresponding to the calculated program execution state to generate sets each including one section and the specified state, for each calculated program execution state, respectively;

a distance calculating unit configured to calculate a distance from the stable set based on a match number between generated sets corresponding to the calculated program execution state and the stable set, for each calculated program execution state, respectively; and

a task execution unit configured to select and execute a next task to be executed next based on calculated distances.

According to an aspect of the present invention, there is provided with a multitask processing device for processing a plurality of tasks, each task being split into at least two sections, comprising:

a stable set storage configured to store a stable set that includes one or more sets each including a section and a state of a shared resource;

a program execution state calculator configured to
calculate, for each selected task selected from the tasks, respectively, a program execution state including
   a section of the selected task where execution is to start when the selected task is next executed and
   current sections of other tasks different from the selected task among the tasks and
specify states of one or more shared resources used at each section of the calculated program execution state for each calculated program execution state, respectively
combine each section of the calculated program execution state with each of one or more specified states corresponding to said each section to generate sets each including one section and one specified state, for each calculated program execution state, respectively;

a distance calculating unit configured to calculate a distance from the stable set based on a match number between generated sets corresponding to the calculated program execution state and the stable set, for each calculated program execution state, respectively; and

a task execution unit configured to select and execute a next task to be executed next based on calculated distances.

According to an aspect of the present invention, there is provided with a multitask processing device for processing a plurality of tasks, each task being split into at least two sections, comprising:

a stable set storage configured to store a stable set that includes one or more sets each including a section and a state of at least one of a shared resource;

a program execution state calculator configured to
calculate, for each selected task selected from the tasks, respectively, a program execution state including
   a section of the selected task where execution is to start when the selected task is next executed and
   current sections of other tasks different from the selected task among the tasks and
specify states of shared resources used at each section of the calculated program execution state for each calculated program execution state, respectively
combine each section of the calculated program execution state with one or more specified states corresponding to said each section to generate sets each including one section and one or more specified states, for each calculated program execution state, respectively;

a distance calculating unit configured to calculate a distance from the stable set based on a match number between generated sets corresponding to the calculated program execution state and the stable set, for each calculated program execution state, respectively; and

a task execution unit configured to select and execute a next task to be executed next based on calculated distances.

According to an aspect of the present invention, there is provided with a multitask processing method for processing a plurality of tasks, each task being split into at least two sections, comprising:

calculating, for each selected task selected from the tasks, respectively, a program execution state including
a section of the selected task where execution is to start when the selected task is next executed and
current sections of other tasks different from the selected task among the tasks;

calculating distances between the program execution states and a stable set including one or more section combinations; and

selecting and executing a next task to be executed next based on calculated distances.

According to an aspect of the present invention, there is provided with a multitask processing method for processing a plurality of tasks, each task being split into at least two sections, comprising:

providing a storage configured to store section characteristic values corresponding to sections;

calculating, for each selected task selected from the tasks, respectively, a program execution state including
a section of the selected task where execution is to start when the selected task is next executed and
current sections of other tasks different from the selected task among the tasks; and

selecting and executing a next task to be executed next based on the section characteristic values of the sections included in each program execution state.

### BRIEF DESCRIPTION OF THE DRAWINGS

FIG. 1 is a block diagram showing a configuration of computer system hardware used to realize a present embodiment;

FIG. 2 is a block diagram showing a multi-CPU system;

FIG. 3 is a functional block diagram of the multitask processing device of the present embodiment;

FIG. 4 is a diagram showing the flow of tasks using sections and checkpoints;

FIG. 5 is a task state transition diagram;

FIG. 6 is a diagram describing processing of a task priority level calculator;

FIG. 7 is a flowchart describing the execution sequence of a scheduler in non-preemptive multitasking;

FIG. 8 is a diagram showing examples of 3 tasks for a more specific description of the sequence shown in FIG. 7;

FIG. 9 is a flowchart describing the execution sequence of a scheduler in preemptive multitasking;

FIG. 10 is a diagram showing an example of how stable distance calculation;

FIG. 11 is a diagram showing a specific example of example [5];

FIG. 12 is a diagram showing an example of memory usage and power consumption for each section;

FIG. 13 is a diagram showing the selection of tasks on a multi-CPU multitasking system;

FIG. 14 is a block diagram showing a remote monitoring device connected via a network to a multitask processing device;

FIG. 15 is a block diagram showing a remote monitoring device connected via a network to a plurality of multitask processing devices;

FIG. 16 is a flowchart describing a different scheduler execution sequence;

FIG. 17 is a flowchart describing a further different scheduler execution sequence;

FIG. 18 shows an example of three tasks and two shared resources;

FIG. 19 shows an example in which two tasks is Task 1 and Task 2 and the shared resources are two shared variables X and Y;

FIG. 20 shows an example in which the number of tasks is two and the shared resource is an object; and

FIG. 21 shows an example in which the number of tasks is three and the shared resource is an object.

### DETAILED DESCRIPTION OF THE INVENTION

The following describes an embodiment of the invention with reference to the drawings.

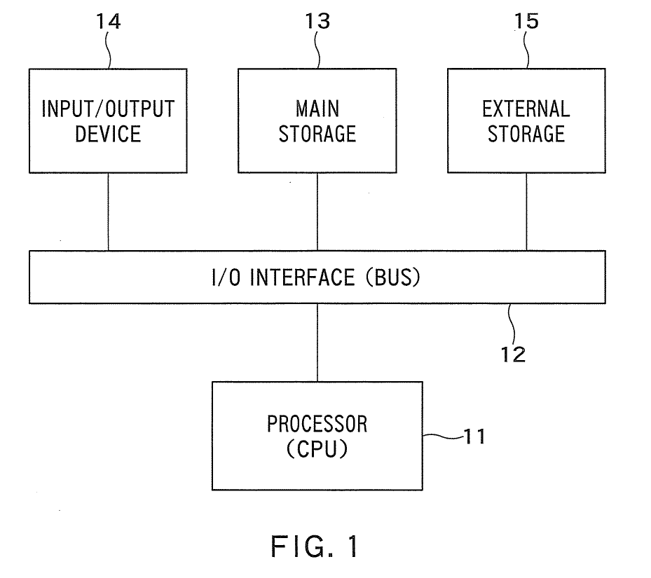

FIG. 1 is a block diagram showing a configuration of computer system hardware used to realize a present embodiment.

The computer system includes a processor 11, and I/O interface (bus) 12, a main storage 13, an input/output device (an input device and an output device) 14, and an external storage 15.

The processor 11 executes software to realize functions of the present embodiment. The processor 11 performs multitask processing of a plurality of tasks under the control of an OS (Operating System). The processor 11 is connected to the I/O interface 12, and is capable of accessing nearby devices, such as the main storage 13, via the I/O interface 12.

The main storage 13 is RAM (Random Access Memory) or some other type of memory, and is used in a cooperative operation in which information is exchanged among tasks.

The input/output device 14 includes devices such as a keyboard and pointing device, and receives various types of command and data input from the user and the environment. The input/output device 14 further includes a display device such as a CRT for displaying text and graphics. The input/output device 14 allows the user and the environment to interact with the computer.

The external storage 15 is capable, using a device such as a magnetic disc drive or magneto optical disk drive, of writing and reading a program code executed on the processor 11 and information used by the program.

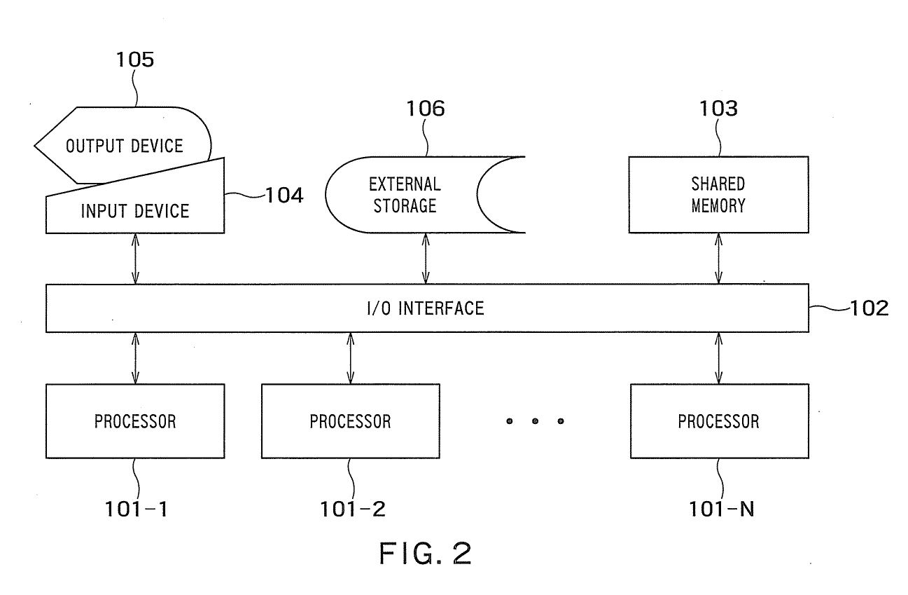

This embodiment describes an example of multitask computing mainly using a single CPU. However, the present embodiment may also be realized on a multi-CPU system as shown in FIG. 2, as well as parallel computers with shared memory, parallel computers without shared memory, and distributed network computer systems. The multi-CPU system of FIG. 2 is described below.

This computer system has a total of N processors 101-1, 101-2, . . . , 101-N. Of the N processors, at least one executes software to realize the functions of the present embodiment. The processors 101-1, 101-2, . . . , 101-N are used to execute tasks of concurrent programs simultaneously and concurrently. Each of the processors 101-1, 101-2, . . . , 101-N, is connected to an I/O interface 102, and is able, via the I/O interface 102, to access surrounding devices such as a shared memory (main storage) 103.

The shared memory device 103 is used to perform cooperative operations in which tasks being executed on the processors 101-1, 101-2, . . . , 101-N exchange information.

The input device 104 includes devices such as a keyboard and pointing device, and receives various types of command and data input from the user and the environment. The output device 105 includes a display device such as a CRT for displaying text and graphics. The input device 104 and output device 105 allow the user and the environment to interact with the computer.

The external storage 106 is capable, using a device such as a magnetic disc drive or magneto optical disk drive, of writing and reading a program code executed on the CPU and information used by the program.

Functions of the present embodiment are realized, as described above, using software. The software achieves the effects of the present embodiment by using the interconnected hardware resources described above. It follows that the configuration and type of the hardware resources can be exchanged for another configuration or type capable of functioning in the same way.

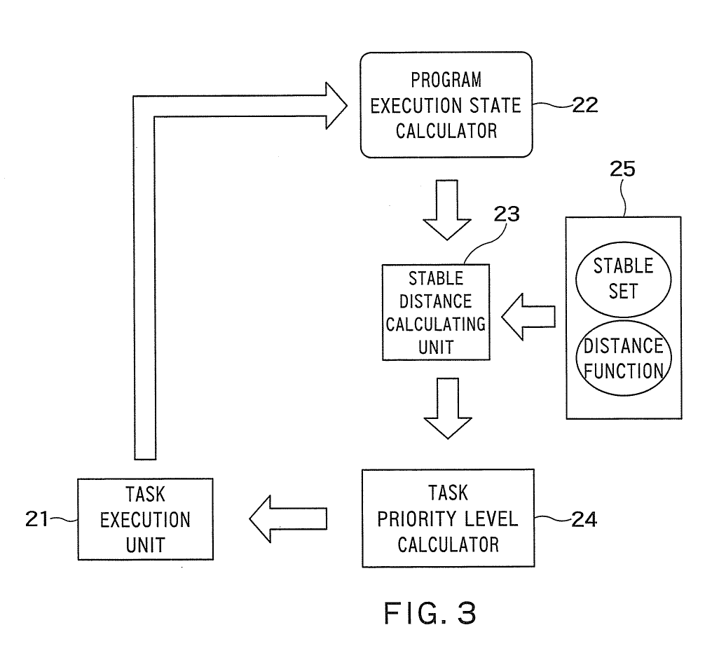

FIG. 3 is a functional block diagram of the multitask processing device of the present embodiment.

This multitask processing device is capable,.for instance, of realizing certain functions of an OS, and includes a task execution unit 21, a program execution state calculator 22, a stable distance calculating unit 23, a task priority level calculator (task selection unit) 24, and a storage 25. The program execution state calculator 22, the stable distance calculating unit 23, and the task priority level calculator (task selection unit) 24 are, for instance, included as part of an OS scheduler. The storage 25 is included as part of a main storage or an external storage.

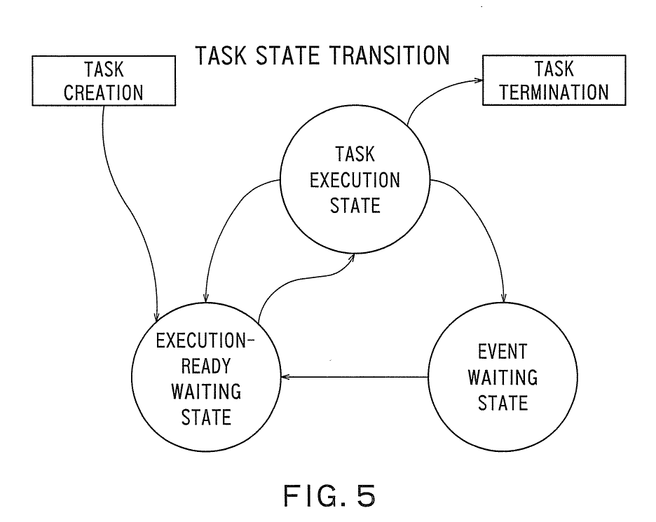

This multitask processing device processes a plurality of tasks (concurrent program). The tasks are executed by the task execution unit 21. The tasks have a “being executed” state (task execution state), an awaiting execution state (execution-ready waiting state), and an event waiting state during which execution is not possible until receiving events (event waiting state). FIG. 5 is a task state transition diagram. Upon task creation, a task moves into the execution-ready waiting state (the task enters the awaiting execution tasklist). The task is then selected as the next task for execution, and executed, at which point the task is in the execution state. When execution of task in the execution state is completed, the task is terminated. Also, if a task switch point (task synchronization commands) is encountered when in the task execution state, the task moves into the execution-ready waiting state or the event waiting state. If the event occurs for which the task has been waiting in the event waiting state, the task moves into the execution-ready waiting state.

The tasks described here are each divided into a plurality of sections. More specifically, at least one “checkpoint command” is pre-inserted in each task, and it is by way of the checkpoint command that the task is divided into the plurality of sections. Points at which checkpoint commands have been inserted in a task are called “checkpoint”. Examples of the way this is achieved in the lava language are seen below in Tasks 1 and 2.

| // Task 1 | |
|---|---|
| class Task1 extends Task{ | |
| private gui gui ; | |
| public Task1(String tname, Resource r){ | |
| super(tname,r) ; | |
| System.out.println(“*** Set Up Task1 ***”) ;} | |
| public void run( ){ | |
| int i = 0, j = 0 ; | |
| while(i++ < 100){ | |
| System.out.println(“*** Task1 running | |
| ***”) ; | |
| arb.check_point(this,1); | ←checkpoint |
| command | |
| j = res.read( ) ; | |
| System.out.println(j) ; | |
| arb.check_point(this,2); | ←checkpoint |
| command | |
| res.write(j−1) ; } | |
| System.out.println(“*** End of Task1 ***”) ; | |
| arb.check_point(this,3) ; ←checkpoint command | |
| gui.task_panel.set_stop(this) ;} | |
| public void set_gui(gui g){ | |
| gui = g ;}} | |
| // task 2 | |
| class Task2 extends Task{ | |
| private gui gui ; | |
| public Task2(String tname, Resource r){ | |
| super(tname,r) ; | |
| System.out.println(“*** Set Up Task2 ***”) ; } | |
| public void run( ){ | |
| int i = 0, j = 0 ; | |
| while(i++ < 100){ | |
| System.out.println(“*** Task2 running | |
| ***”) ; | |
| arb.check_point(this,1) ; | ←checkpoint |
| command | |
| j = res.read( ) ; | |
| System.out.println(j) ; | |
| arb.checK_point(this,2) ; | ←checkpoint |

```
command
                  res.write(j+1) ;}
    System.out.println(“*** End of Task2  ***”) ;
    arb.check_point(this,3) ;  ←checkpoint command
    gui.tasK_panel.set_stop(this) ; }
  public void set_gui(gui g){
    gui = g ; }}
```

This type of task is divided into sections by the checkpoint command. Task 1 and task 2 are each divided into 4 sections using 3 checkpoint commands. When synchronous commands (such as wait and notify) are included in the program, the synchronous commands can be treated as the checkpoint commands.

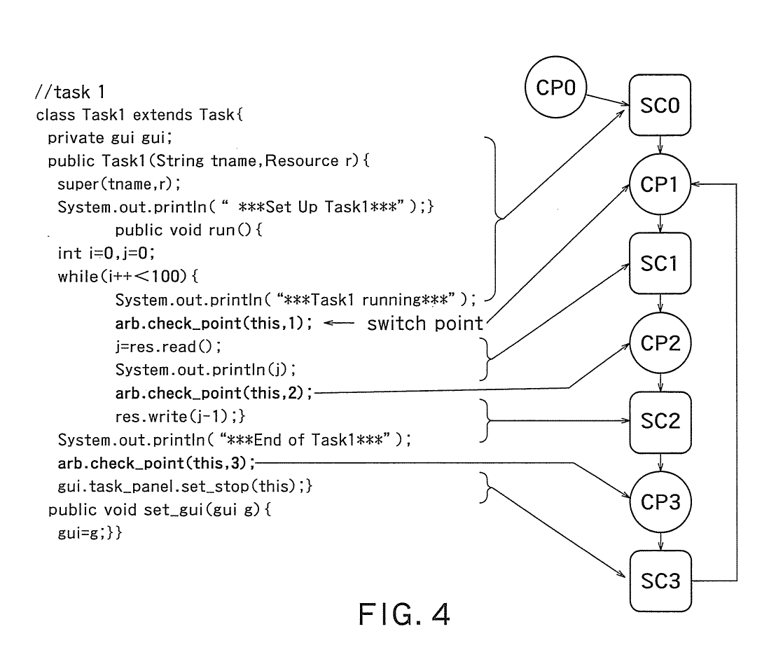

A task can be expressed as a flow of sections and checkpoints. For example, task 1 can be expressed as the flow of sections (SC) and checkpoints (CP) shown in FIG. 4. It is standard practice to put an imaginary checkpoint CP0 at the starting point of the task. The interval between the starting point and the first checkpoint for the task is SC0. A value for recognizing a current section is stored upon execution of the checkpoint command. For example, when arb.chec_point (this, 1) is executed, a value (i.e. checkpoint name; CP1, or section name; SC1) indicating that a section SC1 is the current section is acquired and stored in the main storage 13.

It is possible to express the program execution state s as shown in the following example by a set of latest passed checkpoints of the tasks.

s=(cp11, cp21, cp32, cp43)

cpij: name of latest checkpoint passed through by task i

Note also,

s=(sc11, sc21, sc32, sc43)

scij: name of latest section executed by task i

All combinations of the checkpoints of different tasks (all combinations of the sections of different tasks) are called the “entire program state set S”. The program execution state s is an element of the entire program state set S (sεS). The program execution state s is calculated by the program execution state calculator 22.

A set of the checkpoint combinations which indicate stable program states is called “stable set A”. The stable set A is a subset of the entire program state set S (SεA). Stable set A is given in advance. Stable set A is stored in the storage 25. A more specific example of the stable set A is described later.

An indicator showing how far a program execution state s (sεS) is separated from the stable set A is called “a stable distance Δ(s,A)”. Calculation of the stable distance is performed by stable distance calculating unit 23. The stable distance is calculated using the program execution state s, the stable set A, and a predefined distance function (distance calculating formula) Δ. The distance function Δ is stored in the storage 25. The stable distance calculation unit 23 extracts, at a task switchpoint for example, a set of currently executable tasks TeεT (where T represents a set of all the tasks), and using the current program execution state calculator 22, acquires for the respective tasks in the task set Te, the next program execution states that would result if said task was executed next. A set of next program execution states acquired from the tasks may be represented as S′εS. The stable distance calculating unit 23 uses the stable set and the distance function stored in the storage 25 to calculate the stable distance for each of the program execution states in the set S′. A given stable distance Δ(s,A) represents the distance of the corresponding program execution state s from the stable set A, and is defined so that a smaller stable distance indicates a higher stability. When the program execution state s is included in the stable set, the distance is 0. When all the program execution states belong to the stable set, the situation resembles conventional multi-task processing. An example stable distance calculation will be described later.

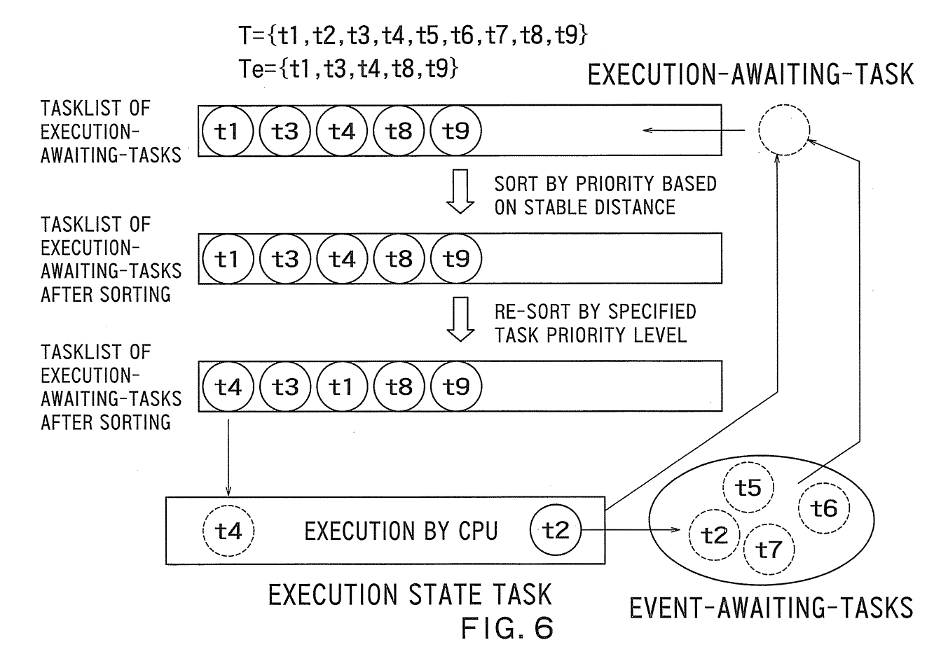

The next task for execution by the task execution unit 21 is found using the task priority level calculator (task selection unit) 24. The task priority level calculator 24 selects the next task for execution from the task set Te based on the stable distances calculated for each task in the task set Te. More specifically, the task priority level calculator 24 selects the task to realize a next program execution state that has the smallest stable distance. In other words, a high priority level (stable task priority level) is attached to tasks that realize a next program execution state with a small stable distance. The processing performed by the task priority level calculator 24 is described below with reference to FIG. 6.

The task priority level calculator 24 selects the next task for execution by using a stable task priority level based on the stable distance, a task priority level specified by the programmer, and an order of arrival of the tasks on the awaiting execution task list. Thus, the task priority level calculator 24 selects the next task for execution on the basis of the following 3 levels of priority:
(1) a priority level assigned by the programmer to each task during programming (specified task priority level)
(2) a level of priority for each task based on the stable distances (stable task priority level)
(3) order of arrival on the awaiting execution task list (arrival order task priority level)

The following describes a case when an order of priorities (1) to (3) is set to be (1)>(2)>(3). With the order of priorities set in this way, the tasks are contained in order of arrival in the awaiting execution task list. Next the tasks on the awaiting execution task list are sorted using the priority level based on stable distance (tasks with higher stable task priority levels are placed towards the head of the line, and where two tasks have the same priority level, the one that arrived first is placed towards the head of the line). Lastly, the tasks are sorted using the priority level specified by the programmer (where two or more tasks specified have the same priority level, the one with higher stable priority level is placed towards the head of the line). The task heading the awaiting execution task list is then selected as the next task for execution. This enables tasks to be executed based on the order of priorities described above. The order of priorities may be set in other ways. For example, if stability is seen to be more important, the level of priority based on the stable distance can be given precedence of the level of priority specified by the programmer. If this is the case, the order of priorities becomes (2)>(1)>(3).

The following is an example of an execution sequence for the multitask processor of FIG. 1. Here, the description deals with a multi-task system on a single CPU, but can be expanded to cover the operation of a normal scheduler in a multitasking system with a plurality of CPUs. In the description the case (non-preemptive multitasking) in which the timing of task switches is determined entirely by the checkpoints (or synchronous commands), and the case (preemptive multitasking) in which it is possible to switch between tasks with any timing are considered separately. The former case has the advantage of a small schedule overhead, but the disadvantage that emergency interrupt tasks cannot be dealt with.

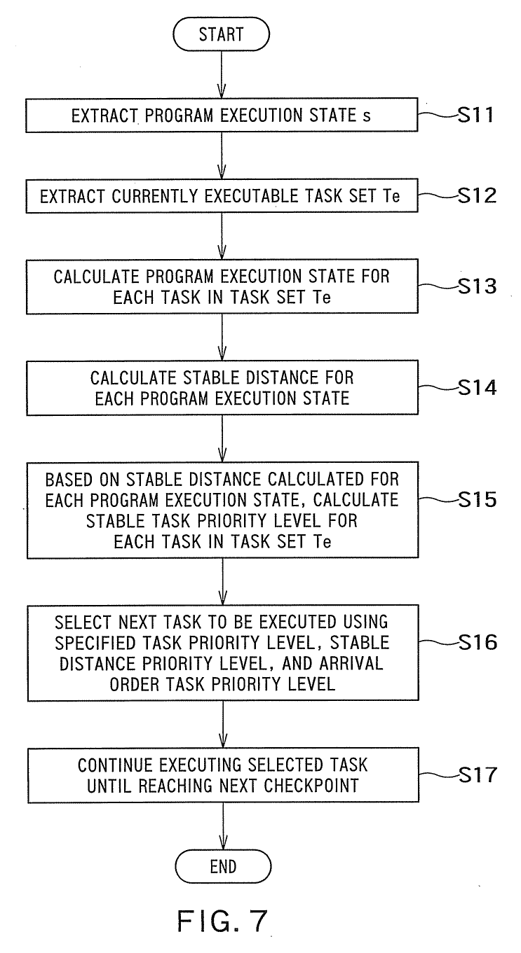

FIG. 7 is a flowchart describing the execution sequence of a scheduler (which includes the program execution state calculator 22, the stable distance calculating unit 23, the task priority level calculator (task selection unit) 24) in non-preemptive multitasking.

First, the program execution state s is extracted. In practice, a combinations of checkpoints (=program execution state) that correspond to current execution sections of each task is extracted (S11). Each task is considered to be in the respective sections preceding these checkpoints.

Next, the currently executable task set Te∪T is extracted from the set of all tasks T (S12).

Next, for each task in the task set Te, the next program execution state after said task is executed is calculated, and the set of next program execution states obtained from the tasks in Te is denoted as S′ (S13).

Next, the prescribed stable set and the distance function are used to calculate the stable distance for each of the program execution states in the set S′ (S14). Note that when, in the distance calculation, the number of tasks in the task set Te is less than the section number included in each element of the stable set, the stable distance may be calculated only for the next program execution states caused by tasks in the task set Te (in the example described above the next program execution states caused by the task in the event waiting state can be ignored).

Next, the stable task priority level is calculated for each task in the task set Te based on the stable distances calculated from the program execution states (S15).

Next, the next task for execution is selected using (1) the specified task priority level, (2) the stable task priority level, and (3) the arrival order task priority level (S16). For example, if the order of priorities is (1)>(2)>(3), the tasks in the awaiting execution task list (awaiting execution queue) are sorted according to (3) then (2) and lastly (1). The task appearing at the head of the awaiting execution task list after sorting becomes the next task for execution.

The selected task is then continued to be executed until the next checkpoint is reached (i.e. until a next checkpoint command is executed) (S17). Thereafter, the processing returns to S11.

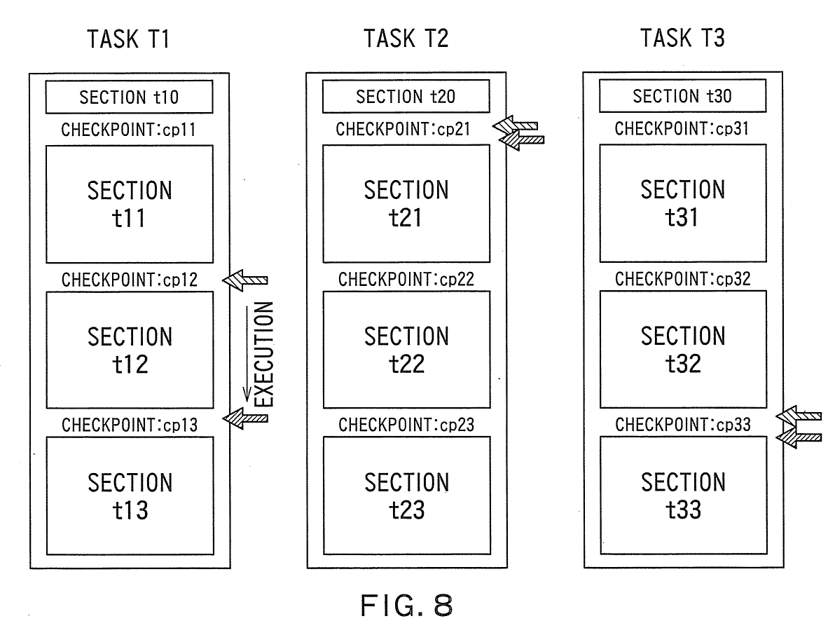

The following is a description of the sequence described above, using the three tasks shown in FIG. 8 as examples.

First, the current program execution state s is extracted. Specifically, the section set s=(t11, t20, t32) is extracted (S11) which shows the current execution section of each of tasks T1 to T3. Each of tasks T1 to T3 is considered to be in the respective sections preceding these checkpoints.

The currently executable task set Te is extracted (S12). Here Te={T1, T2, T3} is extracted.

For each task in the task set Te, the program execution state for when said task is the next task for execution is calculated, and the set of next program execution states obtained from the tasks in Te is denoted as S′ (S13). Here, S′={s1, s2, s3}, s1=(t12, t20, t32), s2=(t11, t21, t32), and s3=(t11, t20, t33).

The prescribed stable set and the distance function are used to calculate the stable distance for each of the next program execution states in the set in S′={s1, s2, s3} (S14).

The stable task priority level is calculated for each task in the task set Te={T1, T2, T3} based on the calculated stable distances (S15). Here, T1>T2>T3.

Next, the next task for execution is selected using (1) the specified task priority level, (2) the stable task priority level, and (3) the arrival order task priority level (S16). For example, if the order of priorities is (1)>(2)>(3), the tasks in the awaiting execution task list (awaiting execution queue) are sorted according to (3) then (2) and lastly (1). The task appearing at the head of the awaiting execution task list becomes the next task for execution Here, it is supposed that the specified task priority levels for each of tasks T1, T2 and T3 were the same, and that task T1 was selected.

The selected task T1 is then executed until the next checkpoint cp13 is reached (S17). Thereafter, the processing returns to S11. At this stage, the new program execution state is s1=(t12, t20, t32).

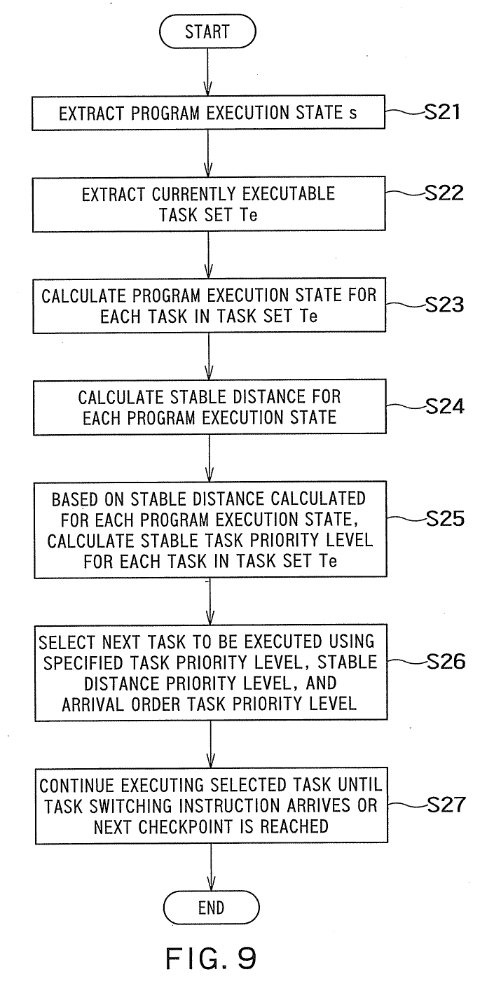

FIG. 9 is a flowchart describing the execution sequence of a scheduler in preemptive multitasking. Here switching between tasks can take place for a various reasons, with any timing and at any position in a section. The reasons include, for example, (1) an external signal, or the like, triggering an interrupt task with a high priority level, (2) the scheduler moving a task that is being executed into the event waiting state for a reason other than the reaching to a checkpoint, (3) a synchronous command (notify command) indicating, during execution of a first task, that a second task with a high priority level as become executable, and (4) an awaited task becoming executable due to the passage of time on a timer. The timing of the task switch is specified by the scheduler. Generally, events such as an interrupt processing occurring on the scheduler side are flagged, the flagging causes a temporary suspension in execution of the task, and control returns to the scheduler. The following describes the execution sequence of this process.

First, the program execution state is extracted. Specifically, a set s is extracted using the latest passed checkpoint in each task (S21).

Next, the currently executable task set Te is extracted from the set of all tasks T (S22).

Next, for each task in the task set Te, the next program execution state after said task is executed is calculated, and the set of program execution states obtained from the tasks in Te is denoted as S′ (S23). Provided the processing is not stopped in a checkpoint (and that it is stopped mid-section), the program execution state is no different.

Since steps S24 to S26 resemble the steps S14 to S16, their description is omitted here.

In step S27, execution of the task selected in step S16 continues until there is an instruction to switch task from the scheduler, or the next checkpoint is reached. Thereafter, the processing returns to step S21.

The following is a description of examples of the stable set A and the stable distance.

### [1] Stabilization of Functional Bugs: 1

The stable set is simply defined by saying that a total number of tasks entering a critical section (a section that accesses common computer resources) is not greater than 1. The critical sections can be extracted automatically by program analysis or may be specified by the user.

Definition of stable set:

A={s=(t1, t2, t3, t4) | the total number of tasks entering a critical section ≦1 in t1, t2, t3, t4}.

Definition of stable distance:

Δ(s, A)=0 if sεA

Δ(s, A)=1 if sεnot A

Thus, a stable set is a set of section combinations (set of program execution states) for which the total number of tasks entering a critical section is 1. If a program execution state to be evaluated is in the stable set, the stable distance is 0 (first value). If the program execution state is not in the stable set, the stable distance is 1 (second value).

Here, the stable set may be calculated in advance and stored in the storage (13 or 15). The calculation to find of whether a program execution state belongs to the stable set can be performed at runtime.

By the above, tasks for which the total number of tasks that will enter the critical section is not greater than 1 have a higher priority level, and multiple tasks are prevented from entering the same critical sections simultaneously.

### [2] Stabilization of Functional Bugs: 2

In this example, the total number of tasks entering the critical section (section which accesses common computer resources) is defined as the stable distance.

Definition of stable distance for program execution state s=(t1, t2, t3, t4):

Δ(s)=the total number of tasks (number of tasks) belonging to a critical section in t1, t2, t3, and t4.

This is to say that if whether each section belongs to the critical section is expressed as a section characteristic value (for example, 1 for sections belonging to the critical section and 0 for sections not belonging to the critical section), Δ(s) will correspond to the number of sections ti having a section characteristic value of 1 in the program execution state s=(t1,t2, . . . ,tn).

Here, it can be considered that there is no stable set (i.e. an empty set), and the stable distance is calculated entirely from the characteristic values. Thus, the desired functions can be realized without a stable set, using only the stable distance calculating formula.

The above allows task scheduling that minimizes the number of tasks entering the critical section.

### [3] Stabilization of Functional Bugs: 3

In this example, the stable set is simply defined by saying that the total number of tasks entering a critical section (the section that accesses common computer resources) is not greater than 1, and the total number of tasks entering the critical section is defined as the stable distance.

Definition of stable set:

A={s=(t1, t2, t3, t4) | the total number of tasks entering a critical section ≦1 in t1, t2, t3, t4}.

Definition of stable distance:

Δ(s, A)=0 if sεA

Δ(s, A)=total number of tasks belonging to a critical section if sεnot A

According to the above, a highest priority level is assigned to tasks for which the total number of tasks that will enter a critical section is 0 or 1 (for 0 and 1 the priority level is equal), and task scheduling that minimizes the number of tasks entering critical sections can be performed, when two or more tasks enter critical sections simultaneously.

### [4] Stabilization of Functional Bugs Using Test Results: 1

In this example, tested section combinations (section combinations on which testing was performed at a testing stage before releasing and shipping) are defined as the stable set.

Definition of stable set:

A={s=(t1, t2, t3, t4) | a section combination (t1, t2, t3, t4) has been tested}

Definition of stable distance:

Δ(s, A)=0 if sεA

Δ(s, A)=1 if sεnot A

The stable set can be calculated in advance and stored in the storage (13 or 15). If the number of states is large, however, storing the stable set in this way may consume a lot of memory. States (sets of section combinations) belonging to the stable set can be efficiently expressed using a Binary Decision Diagram (BDD). It is well-known that when a stable set is expressed in a compact way using a binary decision diagram, it is easy to calculate whether a given program execution state is included (sεA) (Randal E. Bryant, Symbolic Boolean manipulation with ordered binary-decision diagrams, ACM Computing Surveys, Vol. 24, No. 3, pp. 293-318, 1992).

The above allows task scheduling that gives precedence to tested section combinations.

### [5] Stabilization of Functional Bugs Using Test Results: 2

In this example too, tested section combinations are defined as the stable set. In this example, however, the definition of the stable distance differs.

Definition of stable set:

A={s=(t1, t2, t3, t4) | a section combination (t1, t2, t3, t4) has been tested}

Definition of stable distance:

Δ(s, A)=min{δ(s, s′)| s′εA}

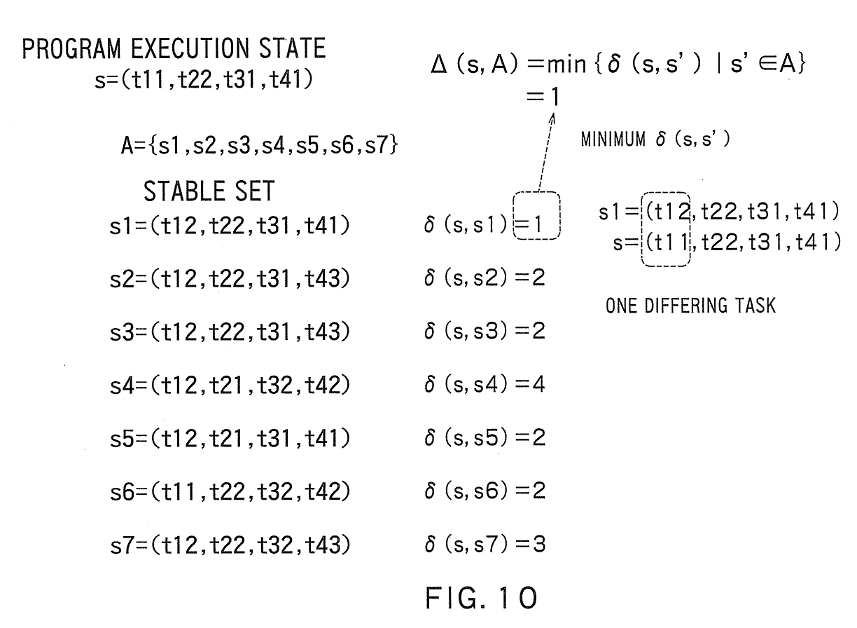

Here, δ(s, s′) is the number non-matching tasks between s and s′, where s is the program execution state being evaluated and s′ is an element in the stable set. Examples of calculated δ(s, s′) are shown in FIG. 10. For example, when s=(t11, t22, t31, t41) and element s1 in stable set A is (t12, t22, t31, t41), there is one mismatch task between s and s1, and so δ(s, s1)=1. Next, δ(s, s′) is found in the same way for all the other elements s2 to s7 in the stable set A, and the minimum value of δ(s, s′) among seven results becomes the stable distance.

The above allows task scheduling that gives precedence to tested section combinations.

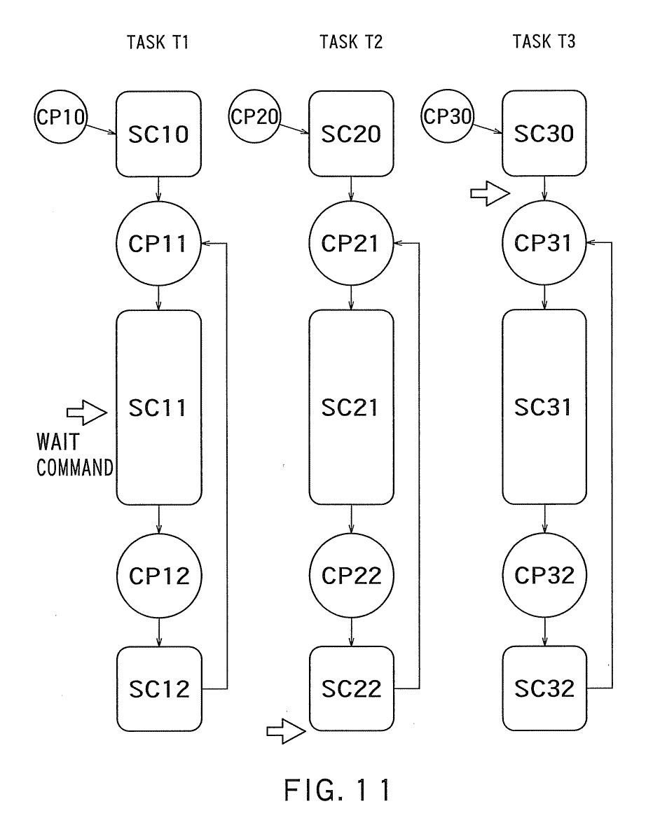

The following is a description of a specific example with reference to FIG. 11.

Suppose there are three tasks T1 to T3, and each task is in the execution-ready waiting state. This to say that a task set T={T1, T2, T3}. Suppose also that the priority levels of the three tasks specified by the programmer (specified task priority levels) are all equal. Further suppose that the stable set has a single element so that A={s′}, and s′=(SC11, SC22, SC32), and that the current program execution state is s=(SC11, SC22, SC30).

During execution of section SC11 of task T1, a wait command causes task T1 to move into the event waiting state, and the task selection unit (scheduler) 24 has to select the next task for execution from tasks T2 and T3 which are in the execution-ready waiting state.

The program execution state for the case that task T2 is executed next is s=(SC11, SC21, SC30), and the stable distance from the stable set is 2 (T2 and T3 are non-matching).

On the other hand, the program execution state for the case that task T3 is executed next is s=(SC11, SC22, SC31), and the stable distance from the stable set is 1 (T3 is non-matching).

Thus, the scheduler selects task T3, and puts task T3 into the execution state. The task execution unit 21 then executes the selected task.

In this example, the stable distance is defined to be the smallest value among the numbers of non-matching tasks, and the task having the smallest stable distance is selected. However, the stable distance may be defined as the largest value among the numbers of matching tasks, in which case the task having the largest stable distance would be selected.

### [6] Stabilization of Functional Bugs Using Test Results: 3

In this example, a sum of the reciprocals of the number of tests performed on each section at a testing stage before releasing and shipping is defined as the stable distance (reciprocals are used to give stable distances that become smaller as the numbers of tests performed on the sections become larger). The reciprocal of the number of tests performed on each section is pre-stored in a table.

Definition of stable distance for a program execution state s=(t1, t2, t3, t4):

Δ(s)=Δ(s,{ })=sum of reciprocals of the number of tests on each of the sections t1, t2, t3, t4

Thus, by expressing the reciprocal of the number of tests on each of the sections as section characteristic values, Δ(s) becomes an indicator of how thoroughly testing was performed on a particular combination of sections.

Here, it can be considered that there is no stable set (i.e. an empty set), and the stable distance is calculated entirely from the characteristic values. Thus, the desired functions can be realized without a stable set, using only the stable distance calculating formula.

According to the above, tasks that realize program execution state with combinations of sections that have been thoroughly tested will be given precedence at selection. This makes it possible in task scheduling to avoid simultaneous executing sections that have not been sufficiently tested.

### [7] Stabilization of Performance Bugs

In this example, the stable set is most simply defined by saying that the power consumption and memory usage are not greater than some constant (α: assumed permitted capacity), and that the set of section combinations (set of program execution states) is the stable set.

With regard to the power consumption, scheduling on a plurality of CPUs must be considered. Information about task scheduling for low power consumption includes for example “Research into multiprocessor scheduling for lower power consumption” from Tokyo University, which can be found at the following URL.

http://www.i.u-tokyo.ac.jp/edu/course/ipc/master/2005/RCAST/watanabe_r.pdf
However these ad hoc methods are not widely applicable.

### (1) Memory Usage: 1 (Assuming Multitasking System on a Single CPU)

Definition of stable set:

A={s=(t1, t2, t3, t4)| sum of estimated memory usage by t1, t2, t3, t4≦α, where α is memory usage that allows problem-free system operation}

Definition of stable distance:

Δ(s, A)=0 if sεA

Δ(s, A)=1 if sεnot A

### (2) Memory Usage: 2 (Assuming Multitasking System on a Single CPU)

Definition of stable set:

A={s=(t1, t2, t3, t4)| sum of estimated memory usage by t1, t2, t3, t4≦α, where α is memory usage that allows problem-free system operation}

Definition of stable distance:

Δ(s, A)=0 if sεA

Δ(s, A)=sum of estimated memory usage by t1, t2, t3, and t4 if Sεnot A

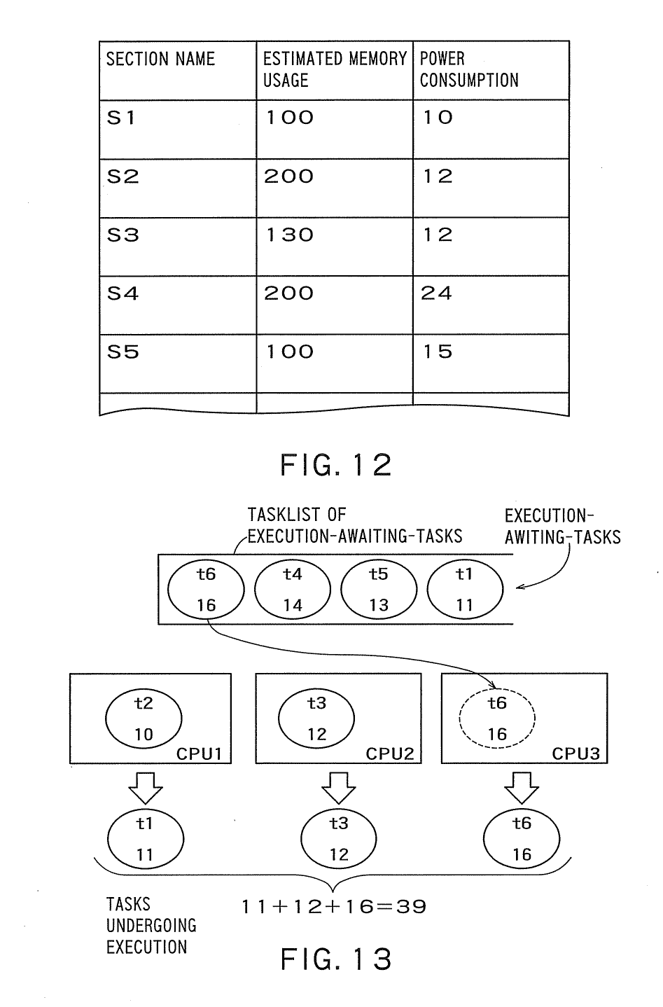

An estimated memory usage (section characteristic value) is a maximum estimated memory usage (or an estimated average memory usage) for each section, and is calculated in advance and stored in a table. An example of the table is shown in FIG. 12. The estimated memory usage for a section is calculated by executing the section individually, and calculating the memory usage. Alternatively, estimated memory usage can be found in a theoretical way by analyzing the program.

The above-described method works to prevent a situation in which memory usage exceeds a permitted level.

(3) Memory usage: 3 (assuming multitasking system on a single CPU)

In this example, a sum of the memory usage by the tasks is defined as the stable distance.

Definition of stable distance for a program execution state s=(t1, t2, t3, t4):

Δ(s)=Δ(s,{ })=sum of estimated memory usage by t1, t2, t3, and t4

The difference from “(2) Memory usage: 2” is that, whereas in (2) the order of priorities for the tasks will remain unchanged if the memory usage is less than or equal to α, in (3) tasks with lower memory usage will still take precedence when the memory usage is all less than or equal to α.

The above allows task scheduling that minimizes the sum of memory usage.

### (4) Power Consumption: 1 (Assuming Multitasking System on a Plurality of CPUs)

In multitasking systems, such as multi-core systems on a single chip, that have multiple CPUs (at least 2 executing units), the tasks can be classified into tasks that are being executed, and tasks that are held awaiting execution on an awaiting execution task list (awaiting execution queue), as shown in FIG. 13. At this stage, task switching takes place on one of the CPUs, and not on the other currently executing CPUs. FIG. 13 shows the selection of a task for CPU3 based on the following stable set and stable distance. It should be notices that calculation of the estimated sum of the power consumptions takes into account the tasks that are currently being executed on CPUs.

Definition of stable set:

A={s=(t1, t2, t3, t4)| sum of estimated power consumptions for execution of tasks by CPUs for t1, t2, t3, t4≦α}

Definition of stable distance:

Δ(s, A)=0 if sεA

Δ(s, A)=1 if sεnot A

The estimated power consumption (section characteristic value) is an estimated maximum power consumption (or estimated average power consumption) for each section, and is calculated in advance and stored in a table. An example of the table is shown in FIG. 12. The estimated power consumption for a section is calculated by executing the section individually, and calculating the amount of power consumed. Alternatively, the estimated power consumption can be found in a theoretical way by analyzing the program.

The above-described method works to prevent a situation in which the power consumption exceeds a permitted level.

### (5) Power Consumption: 2 (Assuming Multitasking System on a Plurality of CPUs)

In this example, the sum of the estimated power consumption by each task is defined as the stable distance.

Definition of stable distance for the program execution state s=(t1, t2, t3, t4):

Δ(s)=Δ(s,{ })=sum of estimated power consumption by t1, t2, t3, and t4

The above allows task scheduling that minimizes the sum of power consumption.

### [8] Stabilization Using Characteristic Values Specified During Program Design: 1

Bugs in concurrent programs tend to occur due to combination of non-main processing, rather than due to main processing which has been properly considered at program design. In this example, a stable distance using a main processing characteristic value for distinguishing between main processing and non-main processing (such as exceptional processing) is defined. More specifically, the characteristic value for sections that are main processing is 0, and the characteristic value for sections that are non-main processing is 1. The characteristic values are specified during program design by the programmer, and stored in table format when the program is executed.

Definition of stable distance for the program execution state s=(t1, t2, t3, t4):

Δ(s)=Δ(s,{ })=sum of main processing characteristic values of t1, t2, t3, and t4.

Here, it can be considered that there is no stable set (i.e. an empty set), and the stable distance is calculated entirely from the characteristic values. The desired functions can be realized without a stable set, using only the stable distance calculating formula.

The above allows task scheduling to be performed in a way that prevents, as far as possible, non-main processing being executed concurrently.

### [9] Stabilization Using Characteristic Values Specified During Program Design: 2

Bugs in concurrent programs are often caused by combining the processing of closely involved tasks. In this example, a characteristic value (section closeness characteristic value) that is specified at program design and represents a degree of closeness between task sections is defined as the stable distance. More specifically the degrees of closeness between all the sections are specified at design by the programmer, and stored in table format when the program is executed. In reality, it is not necessary to specify values for all combinations, and the programmer simply assigns closeness characteristic values to integer greater than 0 when uneasy about the stability of particular combinations. The other closeness characteristic values may all be set to 0. Program analysis methods can be used to analyze the degree of sharing between variables, and the closeness characteristic values can be calculated automatically from the results. Specific calculating methods can be used and are detailed in Myers in his section on module robustness/connectivity (G. J Myers, Composite/Structured Design, Van Nostrand Reinhold, 1978).

Definition of stable distance for the program execution state s=(t1, t2, t3, t4):

Δ(s)=Δ(s,{ })=sum of characteristic closeness values for each of the sections t1, t2, t3, and t4

The above allows task scheduling to be performed in a way that prevents, as far as possible, closer sections being executed concurrently.

### [10] Remote Updating of Stable Sets

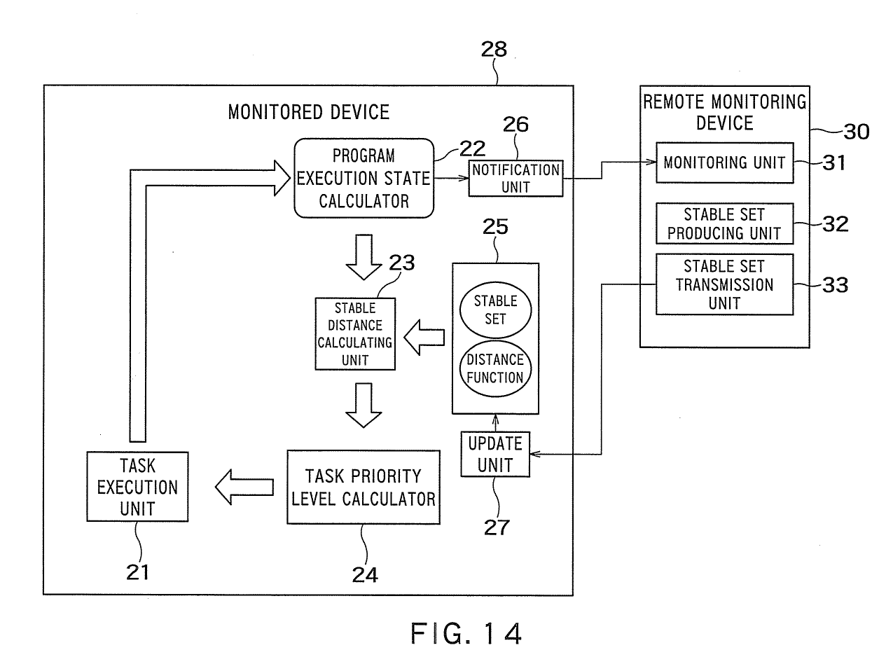

FIG. 14 shows a machine (monitored device) 28 that includes a multitasking processing device, and a remote monitoring device 30 that is connected to the monitored device 28 via a network. The remote monitoring device 30 monitors the program execution state of the monitored device 28, produces a stable set based on the monitoring, transmits the produced stable set to the monitored device 28, and updates a stable set that is being used by the monitored device 28. This allows the functional and performance stability of the machine to be improved base on post-releasing and post-shipping conditions. Conventionally, after a bug in the program was reported, time was required to identify the bug and fix the program, and so the same bug occurred in many machines. In this machine, however, the occurrence of the same bug in other machines can be prevented by monitoring all the machines over the network, removing any program execution state that causes bugs from the stable set and adding the execution state that is shown to be stable to the stable set.

The following describes a sequence of processing performed by the monitored device 28 and the remote monitoring device 30. The sequence includes steps 1 to 3 below.

Step 1: A monitoring unit 31 in the remote monitoring device 30 monitors the program execution state in the monitored device 28.

Step: 2 A stable set producing unit 32 in the remote monitoring device 30 produces a revised version of the stable set based on results of monitoring.

Step 3: A stable set transmission unit 33 in the remote monitoring device 30, transmits the revised version of the stable set to the monitored device 28, where the stable set is exchanged for the revised version (updated).

The following is a detailed description of each of these steps assuming methods from the above examples of [1] Stabilization of functional bugs: 1, [2] Stabilization of functional bugs: 2, [4] Stabilization of functional bugs using test results: 1, and [5] Stabilization of functional bugs using test results: 2.

Step 1: A monitoring unit 31 in the remote monitoring device 30 monitors the program execution state in the monitored device 28.

Specifically, when during program execution the stable distance is greater than 0, the remote monitoring device 30 monitors whether a bug has occurred on the basis of notification received from the notifying unit 26 in the monitored device 28. Every time a task is executed when the stable distance is greater than 0, the notification unit 26 transmits notification of the program execution state at that time point and of whether a bug occurs. When no bug occurs, the monitoring unit 31 extracts the received program execution state as a stable set candidate s, and stores the stable set candidate in a stable set candidate set SC (SC←SC∪{s}). Conversely, when a bug occurs in spite of the stable distance being 0, the received program execution state is stored in a stable set deletion candidate set NSC (NSC←NSC∪{s}). Bugs can be detected from system crashes and hang-ups, and can be determined automatically from operation logs for the reset button and the like. Another possibility is user feedback (such as the user pushing a bug notification button). If, after the stable set candidate is recorded in the stable set candidate set SC, a bug caused by the stable set candidate s is detected in the subsequent program execution, the candidate s is deleted from the SC. If, in FIG. 11, no bug occurs upon execution with s2=(SC11, SC22, SC31) and stable distance 1, s2=(SC11, SC22, SC31) is added to set SC. It may be assumed here that there was no addition to the stable set deletion candidate set NSC.

Step 2: Producing a revised version of the stable set based on results of monitoring.

Specifically, after some specified time period, the accumulated stable set candidates of the set SC are added to the original stable set A to form a revised version of the stable set A′(A′←A∪SC). In the case of FIG. 11, A′={s2}. Here, to simplify the description it is assumed that the original stable set A is the empty set. When a stable set deletion candidate set NSC exists, the stable set has the NSC deleted, and becomes a revised version (A′←A−NSC)

Step 3: The revised version of the stable set is sent to the monitored device 28, where the update unit 27 exchanges the stable sets.

Specifically, the stable set A in the monitored device 28 is exchanged for the revised stable set A′. In the case of FIG. 11, A is exchanged for A′={s2}. After the exchange, the stable distance for s2=(CP11, CP22, CP31) becomes 0.

Note that while in the example the stable set was updated, the stable distance can be updated instead of the stable set.

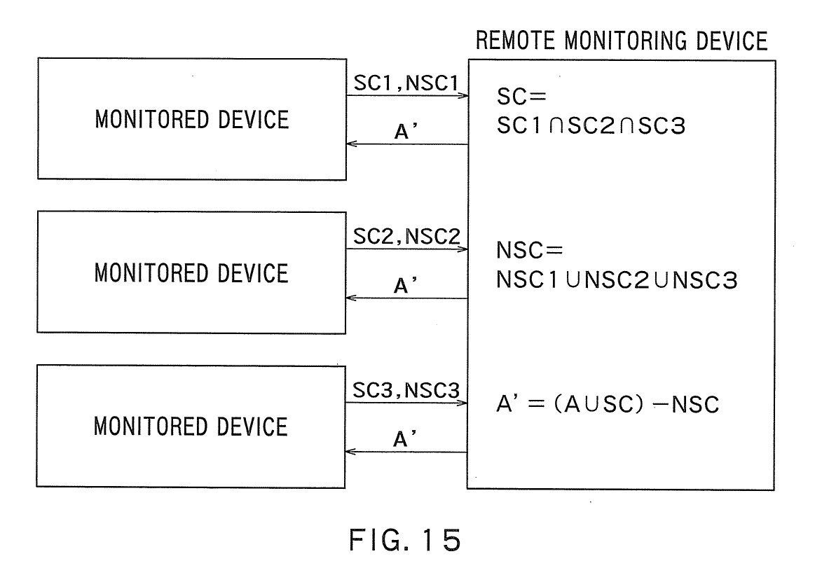

Note also that while the above-described example looked at a single monitored device, FIG. 15 shows an example in which a single remote monitoring device monitors a plurality of monitored devices to produce the stable set for update.

Step 1: The monitoring unit 31 in the remote monitoring device 30 monitors the program execution states in each of the monitored devices 28, and computes, in the above-described manner, the stable set candidate sets SC1, SC2 and SC3 and the stable set deletion candidate sets NSC1, NSC2, and NSC3 for the respective monitored devices 28.

Step 2: Producing a revised version of the stable set based on results of monitoring.

Specifically, a shared set containing the stable set candidate sets SC1, SC2, SC3 calculated for the monitored devices 28 become the stable set candidate set SC, and the set sum of stable set deletion candidate sets NSC1, NSC2, NSC3 becomes the stable set deletion candidate set NSC. The revised version of the stable set is then calculated using SC and NSC (A′=(A∪SC)−NSC). Other calculation methods include having N or more remote monitoring devices and forming the SC or NSC when the same candidates for addition/deletion candidates appear.

Step 3: The revised version of the stable set is sent to the monitored devices 28, where the update unit 27 exchanges the stable sets.

In the above-described examples, the stable set was defined as a set of program execution states satisfying given conditions, but the stable set may be alternatively set up to contain section execution sequence, or, a pair of executable task sets and a selected task (these details will be explained later). Those will be described in a detail below in [11] and [12].

### [11] Stabilization Using Tested Section Execution Sequences

In this example tested section execution sequences are defined as the stable set. For example, if a section ti1 is executed in a directly preceding program execution state s1 and a section ti2 is executed in the following program execution state s2, this tested section execution sequences is saved at testing, and held in table format at execution. This example deals with section execution sequences of length 2, but longer sequences may be held in a similar way.

Definition of stable set:

A={t11t12, t21t22, t31t32, t41t42}, where t11t12, t21t22, t31t32, and t41t42 are tested section execution sequences.

Definition of stable distance:

Δ(s2, A)=0 if ti1tj2εA, where ti1 are a section executed in s1 and ti2 are a section executed in s2

Δ(s2, A)=1 if t11tj2εnot A, where ti1 are a section executed in s1 and ti2 are a section executed in s2

The above allows task scheduling that gives precedence (preference) to tested section execution sequences.

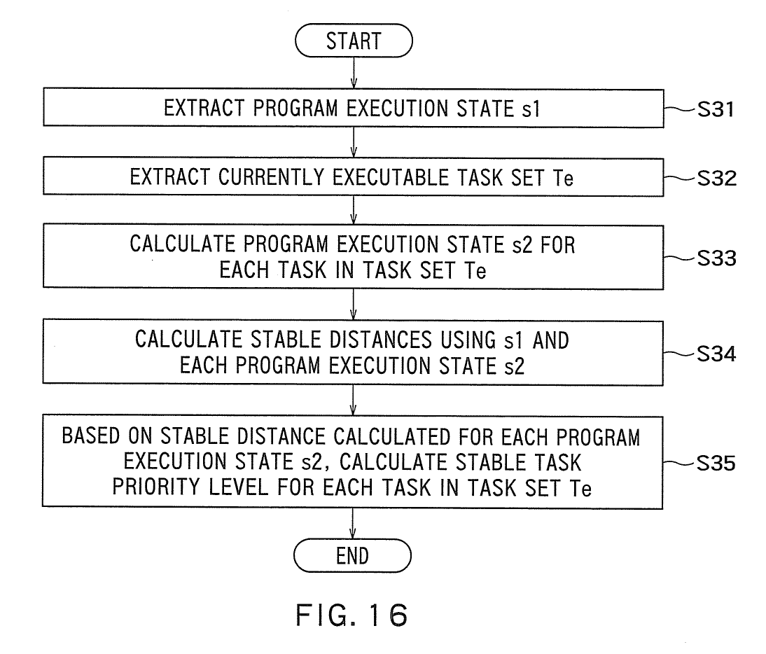

FIG. 16 is flowchart showing an execution sequence of the scheduler when the stable set is formed from tested section execution sequences. First, a program execution state s1 is extracted (S31). Next, the currently executable task set Te is extracted (S32), a program execution state s2 is calculated for each task in the task set Te (S33), the stable distances are calculated based on the above definition by using s1 and each program execution state s2 (S34). The stable task priority level is calculated for each task in the task set Te (S35) based on the stable distance calculated based on each program execution state s2. Task scheduling is performed based on the stable task priority level.

### [12] Stabilization Using a Tested Combination of Executable Task Set and Selected Task

In this example, a tested combination of the executable task set (a set of tasks in execution-ready waiting state) and the selected task is defined as the stable set. For example, with the executable task (section) set SS in the directly preceding program execution state s1, and the section sc to be executed in the next program execution state s2, the combination of the executable task set and the selected task is (SS, sc). If the combination of the executable task sets and selected tasks are properly tested, it is stored in the stable set, and held in table format at execution.

Definition of stable set:

A={(SS, sc) | combination of SS and sc has been tested }

Definition of stable distance:

Δ(s2, A)=0 if the combination of the executable task set SS in s1 and the section sc in s2 is included in A.

Δ(s2, A)=1 if the combination of the executable task set SS in s1 and the section sc in s2 is not included in A.

The above allows task scheduling that gives precedence (preference) to tasks that match tested task selection patterns.

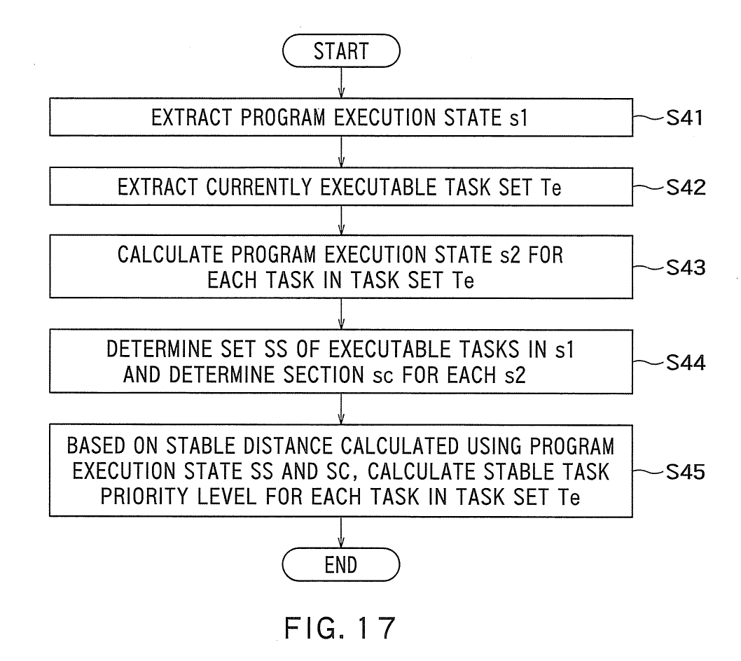

FIG. 17 shows an execution sequence of a scheduler when the stable set is a tested combination of the executable task set and the selected task. First, a program execution state s1 is extracted (S41). Next, the currently executable task set Te is extracted (S42), a program execution state s2 is calculated for each task in the task set Te (S43), the executable task set SS calculated for so and section sc selected for s2 are obtained (S44). Stable distances are calculated using the program execution state SS and each sc, and the stable task priority level is calculated for each of the tasks in task set Te (S45). Task scheduling is then performed based on the stable task priority level.

Subsequently, the stabilization based on a shared resource will be described below in [13]-[16] (the shared resource is, for example, a variable shared among tasks, structured data shared among tasks or an object shared among tasks).

[13] Stabilization Using a Task State (i.e. Section) and a Shared Resource: 1

In this example, combinations between task states (sections) and states of the shared resources, s=(ts,rs), is defined as the stable set wherein the task states have been tested for the states of the shared resources. Normally, combinations of all task states and states of all shared resources, s=(ts,rs), are defined as the stable. Here, a part of the tasks and a part of the shared resource can be excluded if the combinations of tasks and resources have negligible in light of reliability.

Definition of stable set:

A={(ts, rs) | (ts,rs) has been tested}

wherein ts=(t1,t2,t3, . . . ) and rs=(r1,r2,r3 . . . ). ts is a set of task states (i.e. sections) and ti(i=1,2,3, . . . ) is the state of task i. And, rs is a set of the states of the shared resources with respect to ts and ri (i=1,2,3, . . . ) is the state of the shared resource i. ts corresponds to the program execution state.

Definition of stable distance:

Δ(s, A)=0 if sεA.

Δ(s, A)=1 if sεnot A.

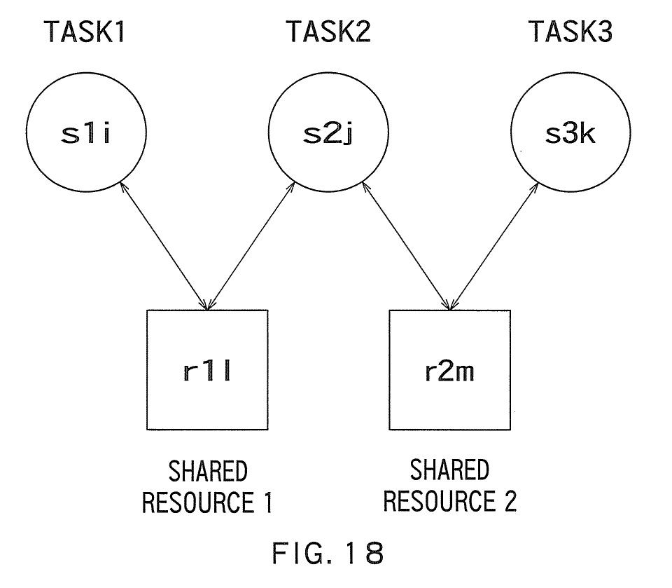

Calculation example of the stable distance will be explained as follows. FIG. 18 shows an example of three tasks and two shared resources. For the combination (s1i, s2j, s3k, r1l, r2m), it is determined whether or not the combination has been tested (i.e. the combination belongs to the stable set A) and if so, the stable distance is 0 or if not so, the stable distance is 1.

The task selection processing using the stable set defined in the present embodiment [13] is the same as those shown in the flowchart of the FIG. 7 or FIG. 9.

However, in the step S13 or S23, besides the program execution state, the states of the shared resources used in the program execution state are found. In the step S14 or S24, calculated is then the distance between a set of the program execution state and the states of the shared resources and the stable set according to the definition of the stable distance.

[14] Stabilization Using a Task State (i.e. Section) and a Shared Resource: 2

In this example, combinations between task states and states of the shared resources, s=(ts,rs), is defined as the stable set wherein each of the task states have been tested for the states of the shared resources. Normally, combinations between all task states and states of all shared resources, s=(ts,rs), are defined as the stable. Here, a part of the tasks and a part of the shared resource can be excluded if the combinations of tasks and resources have negligible in light of reliability.

Definition of stable set:

A={(ts, rs) | (ti,rs) has been tested for each ti of ts}

wherein ts=(t1,t2,t3, . . . ) and rs=(r1,r2,r3 . . . ). tie {t1, t2, t3, . . . } is the state of task i and, rs is a set of the states of the shared resources. Though a set of task states ts and the states of the shared resources has been tested in the forementioned embodiment [13], in present embodiment [14], the stable set is defined in accordance with whether combinations of individual task state of ts and the states of the shared resources has been tested.

Definition of stable distance:

Δ(s, A)=0 if sεA.

Δ(s, A)=(number of all tasks)−(number of tasks each of which has been tested with ts) if sεnot A.

Calculation example of the stable distance will be explained by FIG. 18 as follows. In FIG. 18, the combination (s1i, s2j , s3k , r1l, r2m ) is decomposed so that (s1i, r1l, r2m ), (s2j , r1l, r2m ) and (s3k , r1l, r2m ) are obtained, and (s1i, r1l, r2m ), (s2j , r1l , r2m ) and (s3k , r1l , r2m ) are then determined on whether each has been tested. If one of those has been tested, the stable distance is 2 (=3−1). As a premise, tested (ts, rs) is acquired in advance based on execution log obtained at a time of the test, the (ts, rs) is then decomposed into plural (ti, rs) and the plural (ti, rs) are stored in a list L (stable set). The stable set is coherent concept and in practical algorism, if the stable distance is 0, then the (ts, rs) belongs to the stable set.

The task selection processing using the stable set defined in the present example [14] is the same as those shown in the flowchart of the FIG. 7 or FIG. 9.

However, in the step S13 or S23, besides the program execution state, the states of the shared resources used in the program execution state are found.

In the step S14 or S24, individual section (task state) included in the program execution state is combined with the states of the shared resources to generate plural sets each including one section (task state) and the states of the shared resources. The number of sets not included in the List (stable set) among the generated plural sets is calculated as the stable distance (alternatively, the number of sets matching between the generated plural sets and the list L may be calculated as the stable distance).

In the step S15 or S25, a high priority level (stable task priority level) is given to tasks in priority order that (ti, rs) associated with selected task has been tested and the stable distance of the selected task is short.

[15] Stabilization Using a Task State (i.e. Section) and a Shared Resource: 3

In this example, combinations of task states and states of the shared resources, s=(ts,rs), is defined as the stable set wherein each of the task states have been tested for individual shared resource associated with each task state. Here, “the task is associated with the state of the shared resource” means that the task uses (e.g. refer or update) the shared resource.

Definition of stable set:

A={(ts, rs) | (ti,rik) have been tested for each ti of ts and each shared resource rikε{r1, r2, r3, . . . } associated with each task i}

wherein ts=(t1,t2,t3, . . . ) and rs=(r1,r2,r3 . . . ). tiε{t1, t2, t3, . . . } is the state of task i, {ri1, ri2, ri3, . . . } is a set of the states of the shared resources associated with the state ti and rikε{ri1, ri2, ri3, . . . } is individual shared resource associated with the state ti.

Definition of stable distance:

Δ(s, A)=(number of all combinations of each task and individual shared resource associated with each task)−(number of combinations in which (ti, rik) has been tested).

Calculation example of the stable distance will be explained by FIG. 18 as follows. In FIG. 18, the combination (s1i , s2j , s3k , r1l , r2m ) is decomposed so that (s1i , r1l ), (s2j , r1l ), (s2j , r2m ) and (s3k , r2m ) are obtained, and (s1i , r1l ), (s2j , r1l ), (s2j , r2m ) and (s3k , r2m ) are then determined on whether each has been tested. If one of those has been tested, the stable distance is 3 (=4−1). As a premise, tested (ts, rs) is acquired in advance based on execution log obtained at a time of the test, the (ts, rs) is then decomposed into plural (ti, rik) and the plural (ti, rik) are stored in a list L (stable set). The stable set is coherent concept and in practical algorism, if the stable distance is 0, then the (ts, rs) is treated as belonging to the stable set.

The task selection processing using the stable set j defined in the present example [15] is the same as those shown in the flowchart of the FIG. 7 or FIG. 9.

However, in the step S13 or S23, besides the program execution state, the states of the shared resources associated with the state of each task used in the program execution state are found.

In the step S14 or S24, individual section (task state) included in the program execution state is combined with each of the states of the shared resources associated with individual section (task state) to generate plural sets each including one section (task state) and one of states of the shared resources associated with the one section. The number of combinations not included in the list L among the generated plural sets is calculated as the stable distance (alternatively, the number of combinations matching between the generated plural sets and the list L may be calculated as the stable distance).

In the step S15 or S25, a high priority level (stable task priority level) is given to tasks in priority order that (ti, rik) associated with selected task i has been tested and the stable distance of the selected task i is short, wherein the (ti, rik) is the combination of the state ti of task i and the state rik associated with the state ti.

[16] Stabilization Using a Task State (i.e. Section) and a Shared Resource: 4

In this example, combinations between task states and states of the shared resources, s=(ts,rs), is defined as the stable set wherein each of the task states have been tested for the sets of states of the shared resources associated with each task state.

Definition of stable set:

A={(ts, rs) | (ti,rsi) have been tested for each ti of ts and rsi associated with task i, wherein rsi is the set of states of the shared resources associated with task i and rsi⊂rs} wherein ts=(t1,t2,t3, . . . ), rs=(r1,r2,r3 . . . ) and rsi=(ri1, ri2, ri3, . . . ). tiε{t1, t2, t3, . . . } is the state of task i, rsi⊂rs is a set of the states of the shared resources associated with the state ti and rik ε{ri1, ri2, ri3, . . . } is individual shared resource included in rsi.

Definition of stable distance:

Δ(s, A)=(number of tasks)−(number of tasks in which (ti, rsi) has been tested).

Calculation example of the stable distance will be explained by FIG. 18 as follows. In FIG. 18, the combination (s1i , s2j , s3k , r1l , r2m ) is decomposed so that (s1i , r1l ), (s2j , r1l , r2m ) and (s3k , r2m ) are obtained, and (s1i , r1l ), (s2j , r1l, r2m ) and (s3k , r2m ) are then determined on whether each has been tested. If one of those has been tested, the stable distance is 2 (=3−1). As a premise, tested (ts, rs) is acquired in advance based on execution log obtained at a time of the test, the (ts, rs) is then decomposed into plural (ti, rsi) and the plural (ti, rsi) are stored in a list L (stable set). The stable set is coherent concept and in practical algorism, if the stable distance is 0, then the (ts, rs) is treated as belonging to the stable set.

The task selection processing using the stable set defined in the present example [16] is the same as those shown in the flowchart of the FIG. 7 or FIG. 9.

However, in the step S13 or S23, besides the program execution state, the states of the shared resources associated with the state of each task used in the program execution state are found.

In the step S14 or S24, individual section (task state) included in the program execution state is combined with the states of the shared resources associated with individual section (task state) to generate plural combination each including one section (task state) and the set of states of the shared resources associated with the one section. The number of combinations not included in the list L among the generated plural combinations is calculated as the stable distance (alternatively, the number of sets matching between the generated plural combinations and the list L may be calculated as the stable distance).

In the step S15 or S25, a high priority level (stable task priority level) is given to tasks in priority order that (ti, rsi) associated with selected task i has been tested and the stable distance of the selected task i is short.

### [17] Stabilization Using Observed Likely Invariant

Though the stabilization using a task state and a shared resource is explained until now in the embodiment [13]-[16], accumulating tested shared resources is not practical in many cases since the number of the tested shared resources to be accumulated increases explosively. In the present embodiment [17], features of the tested combinations of task states and the shared resource states cam be found approximately as the observed likely invariant, and based on the founded observed likely invariant, the stabilization is performed.

Here, the observed likely invariant is a likely invariant extracted from the log (history of the program execution states) obtained when a program is executed for test cases prepared in advance. As the observed likely invariant, there is a condition satisfied for a variable, a condition satisfied between variables and the like. As an example of the former, there are X=1, 0<X<100, X!=null and like with respect to the variable X. To extract the likely invariant, used can be Daikon (http://people.csail.mit.edu.mernst/pubs/daikon-tool-scp2007.pdf) developed by MD Ernst's study group of Massachusetts Institute of Technology or Agitator (http://www.agitar.com/) developed by Agitator Co.

In the present embodiment [17], combinations of task states and states of the shared resources are defined as the stable set wherein relationship between the task states and the states of the shared resources in the combination satisfy the observed likely invariant.

Definition of stable set:

A={(ts, rs) | (ti,rsi) satisfies the observed likely invariant for each ti of ts}

wherein ts=(t1,t2,t3, . . . ), rs=(r1,r2,r3 . . . ) and rsi=(ri1, ri2, ri3, . . . ). tiε{t1, t2, t3, . . . } is the state of task i, rsi⊂rs is a set of the states of the shared resources associated with the state ti and rikε{ri1, ri2, ri3, . . . } is individual shared resource included in rsi.

Definition of stable distance:

Δ(s, A)=(number of all tasks)−(number of tasks in which (ti, rsi) satisfies the observed likely invariant).

For the calculation of the stable distance in practice, the observed likely invariant is preliminarily found for shared variables associated with respective ti on the basis of execution log and stored in a list L. Based on the list L, it is then determined whether (ti, rsi) satisfies the observed likely invariant. The stable set is coherent concept and in practical algorism, if the stable distance is 0, then the (ts, rs) is treated as belonging to the stable set.

The task selection processing using the stable set defined in the present example [17] is the same as those shown in the flowchart of the FIG. 7 or FIG. 9.

However, in the step S13 or S23, besides the program execution state, the states of the shared resources associated with the state of each task used in the program execution state are found.

In the step S14 or S24, individual section (task state) included in the program execution state is combined with the states of the shared resources associated with individual section (task state) to generate plural sets each including one section (task state) and the states of the shared resources associated with the one section. The number of combinations that satisfy the observed likely invariant is subtracted from the number of tasks and resultant value is obtained as the stable distance.

In the step S15 or S25, a high priority level (stable task priority level) is given to tasks in priority order that (ti, rsi) associated with selected task i satisfies the observed likely invariant and the stable distance of the selected task i is short.

Three examples of the task selection processing based on the likely invariant will be described as below.

### EXAMPLE 1

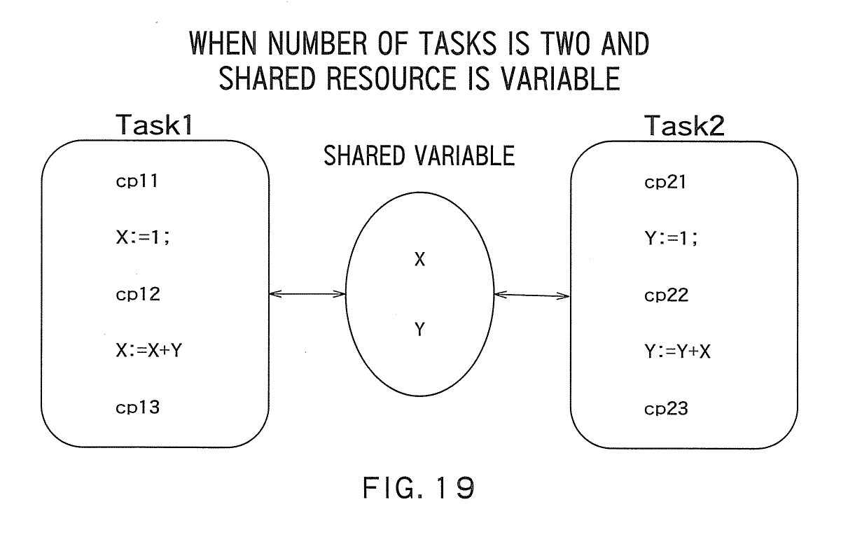

Example in which the number of tasks is two and the shared resource is a variable will be explained by using FIG. 19 below.

In FIG. 19, two tasks is Task 1 and Task 2 and the shared resources are two shared variables X and Y.

Two observed likely invariant are obtained as below in advance.

Linv (cp12, {X,Y})={Y!=null}: Y is not null with respect to the shared variables X and Y in the section following the cp12.

Linv (cp22, {X,Y})={X!=null}: X is not null with respect to the shared variables X and Y in the section following the cp22.

In the above example, Task 1 and Task 2 are controlled to not advance to the subsequent section until both of them advance to the cp12 and cp22 and thereby occurrence of a bug based a null variable can be avoided.

As another example, following two observed likely invariant are obtained in advance.

Linv (cp12, {X,Y})={Y=1}: Y is 1 with respect to the shared variable X and Y in the section following the cp12.

Linv (cp22, {X,Y})={X!=null}: X is not null with respect to the shared variable X and Y in the section following the cp22.

In the above example, Task 1 and Task 2 are controlled to not advance to the subsequent section until both of them advance to the cp12 and cp22. Furthermore, supposed that priority is given to a task satisfying more restricted condition among the tasks, since {Y=1} is more restricted than {X!=null}, Task 1 is controlled to be processed preferentially in first when both of Task 1 and Task 2 are located in cp12 and cp22.

### EXAMPLE 2

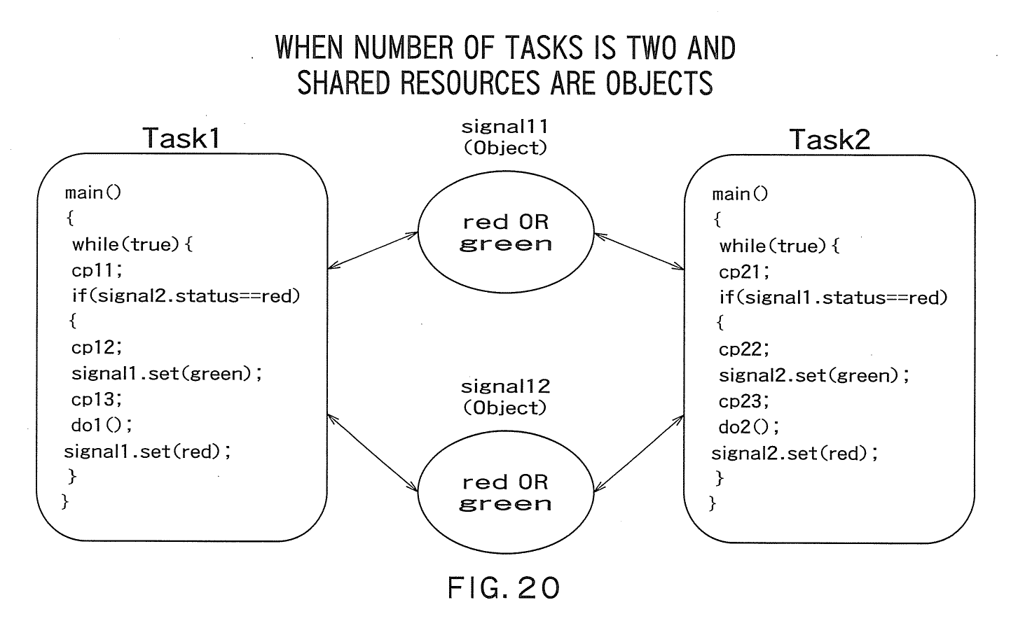

Example in which the number of tasks is two and the shared resource is an object will be explained by using FIG. 20 below.

In FIG. 20, two tasks is Task 1 and Task 2 and the shared resources are two objects “signal1” and “signal2”.

Two observed likely invariant are obtained as below in advance.

Linv (cp13, {signal1, signal2})={signal1.status==green, signal2.status==red}: status of signal1 is green and status of signal2 is red in the section following the cp13.

Linv (cp23, {signal1, signal2})={signal1.status==red, signal2.status==green}: status of signal1 is red and status of signal2 is green in the section following the cp23.

According to timing stabilization based on the above constraint, the following bug can be avoided that Task 1 and Task 2 operate functions do1( ) and do2( ) when signal1 and signal2 is in green at the same time. That is, when a specification forbidding to operate the functions do1( ) and do2( ) at the same time is implicitly present and the specification is satisfied by the execution log, the specification is realized by selecting the task to be executed based on the above observed likely invariant.

### EXAMPLE 3

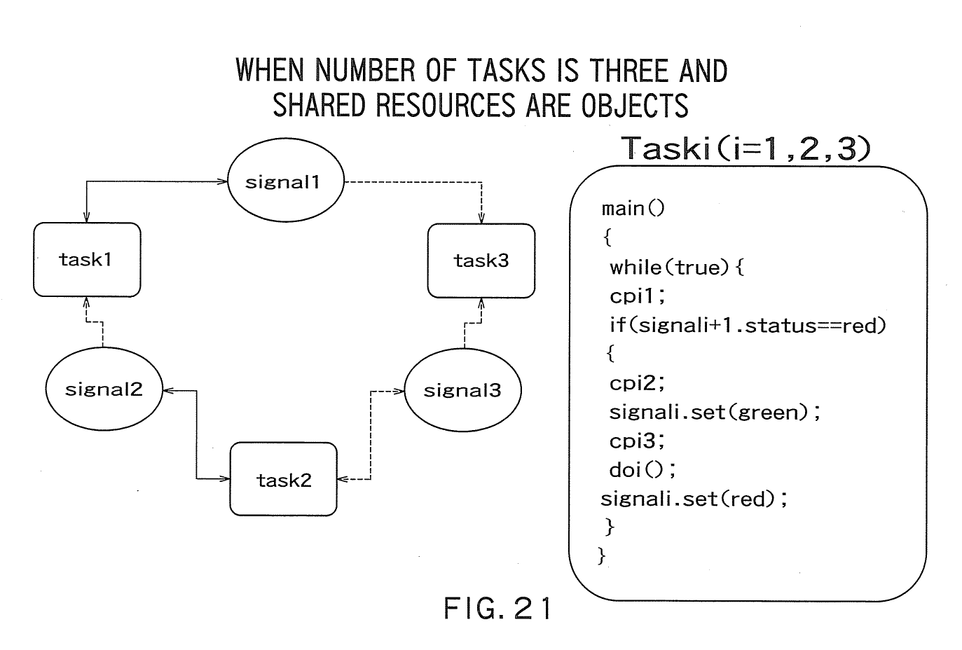

Example in which the number of tasks is three and the shared resource is an object will be explained by using FIG. 21 below.

In FIG. 21, three tasks is “Task i” (i=1, 2, 3) and the shared resources are three objects “signal i” (i=1, 2, 3).

Two observed likely invariant are obtained as below in advance.

Linv (cp13, {signal1, signal2})={signal1.status==green, signal2.status==red}: status of signal1 is green and status of signal2 is red in the section following the cp13.

Linv (cp23, {signal2, signal3})={signal2.status==green, signal3.status==red}: status of signal2 is green and status of signal3 is red in the section following the cp23.

Linv (cp33, {signal3, signal1})={signal3.status==green, signal1.status==red}: status of signal3 is green and status of signal1 is red in the section following the cp33.

According to timing stabilization based on the above constraint, the following bug can be avoided that functions do1( ) and do2( ), do2( ) and do3( ), and do3( ) and do1( ) are operated at the same time, respectively. That is, when a specification forbidding to operate the functions do1( ) and do2( ), do2( ) and do3( ), and do3( ) and do1( ) at the same time respectively is implicitly present and the specification is satisfied by the execution log, the specification is realized by selecting the task to be executed based on the above observed likely invariant.

Subsequently, the updating processing of the stable set based on the observed likely invariant will be described with respect to the system shown in FIG. 14 as stated above.

The monitoring unit 31 in the remote monitoring device 30 monitors the execution state of the program in the monitored device 28. The storage 25 in the monitored device 28 includes the stable set based on the observed likely invariant, given before releasing and shipping. The storage 25 may includes the execution log from which the observed likely invariant is extracted.

The stable set producing unit 32 in the remote monitoring device 30 collects the program execution states which satisfy the observed likely invariant and do not include a bug, as trace information wherein the program execution states are sequentially monitored by the monitoring unit 31. The existing observed likely invariant is updated based on the execution log accumulated additionally by the stable set producing unit 32 and thereby the updated stable set is obtained (i.e. a new stable set is produced).

The stable set transmission unit 33 transmits the updated stable set to the monitored device 28. The update unit 27 in the monitored device 30 replaces the existing stable set with the updated stable set.

When a bug occurs in the monitored device 28, cause of the bug may be found by using history of derogation from the stable set (i.e. program execution states that deviates from the stable set) and the trace information.

As described above, the embodiments of the present invention provides technology to support the development and execution of highly reliable (functionally stable) and stable programs. This technology enables efficient development of large scale programs with high levels of stability in both function and performance, and will therefore improve productivity in program development.

What is claimed is:

1. A multitask processing device for processing a plurality of tasks, each task being split into at least two sections, comprising:
a stable set storage configured to store a stable set including one or more section combinations;
a program execution state calculator configured to calculate, for each selected task selected from the tasks, respectively, a program execution state including
a section of the selected task where execution is to start when the selected task is next executed and
current sections of other tasks different from the selected task among the tasks;
a distance calculating unit configured to calculate distances between the program execution states and the stable set; and
a task execution unit configured to select and execute a next task to be executed next based on calculated distances.

2. The device according to claim 1, wherein
the distance calculating unit calculates a first value as the distance when the stable set includes the section combination having same sections as the program execution state, and a second value different from the first value as the distance when the stable set fails to include the section combination having same sections as the program execution state, and
the task execution unit selects the next task by giving priority to tasks having the first value.

3. The device according to claim 1, wherein
each section combination included in the stable set storage defines that a total number of tasks accessing predetermined calculation resources is not over a first threshold value, or that a total memory usage of tasks is not over a second threshold value.

4. The device according to claim 1, wherein
the distance calculating unit calculates a mismatch number in sections between the program execution state and each section combination included in the stable set storage, and obtains a smallest mismatch number as the distance between the program execution state and the stable set.

5. The device according to claim 1, wherein
the distance calculating unit calculates a match number in sections between the program execution state and each section combination included in the stable set storage and obtains a largest match number as the distance between the program execution state and the stable set.

6. The device according to claim 1, further comprising
a memory-usage information storage configured to store correspondence information between sections and memory usages, wherein
each section combination included in the stable set storage defines to suppress a total memory usage by the tasks to less than a second threshold value or equal, and
the distance calculating unit calculates
a first value as the distance when the stable set includes the section combination having same sections as the program execution state, and
a total of the memory usages corresponding to sections included in the program execution state as the distance when the stable set fails to include the section combination having same sections as the program execution state.

7. The device according to claim 1, further comprising
the task execution unit has two or more execution units to execute tasks,
each section combination in the stable set storage defines to suppress a total power consumption of tasks executed by the executing units to less than a third threshold value or equal,
the program execution state calculator calculates, for each of tasks not being executed, the program execution state including current sections of the tasks being executed and a section to be started when the task not being executed is next executed, and
the distance calculating unit calculates
a first value as the distance when the stable set includes the section combination having same sections as the program execution state, and
a second value different from the first value as the distance when the stable set fails to include the section combination having same sections as the program execution state.

8. The device according to claim 1, further comprising
a power consumption information storage configured to store correspondence information between sections and power consumptions, wherein
the task execution unit has two or more execution units to execute tasks,
each section combination in the stable set storage defines to suppress a total power consumption of tasks executed by the executing units to less than a third threshold value or equal,
the program execution state calculator calculates, for each of tasks not being executed, the program execution state including current sections of the tasks being executed and a section to be started when the task not being executed is next executed, and
the distance calculating unit calculates
a first value as the distance when the stable set includes the section combination having same sections as the program execution state, and
a total of the power consumptions corresponding to sections included in the program execution state as the distance when the stable set fails to include the section combination having same sections as the program execution state.

9. The device according to claim 1, wherein
the task execution unit
determines first priority levels for the tasks based on the calculated distances,
when a task number of tasks having a highest first priority level is one, selects the one task as the next task,
when the task number of the tasks having the highest first priority level are two or more, selects one or more tasks having a highest second priority level from among the two or more tasks having the highest first priority level wherein the second priority levels are assigned to the tasks in advance,
when a task number of selected tasks having the highest second priority level is one, selects the selected task as the next task, and
when the task number of the selected tasks having the highest second priority level is two or more, selects a task that has been fastest to reach an execution-ready waiting state as the next task, from among the two or more tasks having the highest second priority level.

10. The device according to claim 1, wherein
the task execution unit
selects one or more task having a highest second priority level wherein the second priority levels are assigned to the tasks in advance,
when a task number of selected tasks is one, selects the one task as the next task,
when the task number of selected tasks are two or more, determines a first priority level for each of the two or more tasks based on the distances calculated for the two or more tasks,
when a task number of tasks having the highest first priority level is one, selects the one task as the next task, and
when the task number of tasks having the highest first priority level are two or more, selects a task that has been fastest to reach an execution-ready waiting state as the next task, from among the two or more tasks having the highest first priority level.

11. The device according to claim 1, further comprising:
a notification unit configured to test whether a bug has occurred as a result. of task execution and notify a pre-specified remote monitoring device with information indicating
a program execution state corresponding to the task executed and
whether the bug has occurred; and
an update unit configured to receive data including an updated stable set from the remote monitoring device and update the stable set in the stable set storage using received data.

12. A multitask processing device for processing a plurality of tasks, each task being split into at least two sections, comprising:
a stable set storage configured to store a stable set having at least one section sequence which includes N sections being successive (where N is an integer greater than or equal to two);
a section calculating unit configured to calculate, for each of the tasks, a section where execution is to start when the task is next executed;
a distance calculating unit configured to calculate, for each of the tasks, a distance between
a section sequence that includes a section calculated by the section calculating unit and N-1 sections that were executed immediately before and
the stable set; and
a task execution unit configured to select and execute a next task to be executed next based on calculated distances.

13. A multitask processing device for processing a plurality of tasks, each task being split into at least two sections, comprising:
a stable set storage configured to store a stable set having at least one set of one or more task and a section;
a section calculating unit configured to calculate, for each of executable tasks in an execution-ready waiting state among the tasks, a section where execution is to start when the executable task is next executed;
a distance calculating unit configured to calculate, for each of the executable tasks, a distance between
a set of the executable tasks and the section calculated by the section calculating unit and
the stable set; and
a task execution unit configured to select and execute a next task to be executed next among the executable tasks based on calculated distances.

14. A multitask processing device for processing a plurality of tasks, each task being split into at least two sections, comprising:
a storage configured to store section characteristic values corresponding to sections;
a program execution state calculator configured to calculate, for each selected task selected from the tasks, respectively, a program execution state including
a section of the selected task where execution is to start when the selected task is next executed and
current sections of other tasks different from the selected task among the tasks; and
a task execution unit configured to select and execute a next task to be executed next based on the section characteristic values of the sections included in each program execution state.

15. The device according to claim 14, wherein
the section characteristic value indicates whether access to a prescribed computer resource is performed in the section corresponding to the section characteristic value, and
the task execution unit calculates a total number of tasks that access the prescribed calculator resource in each program execution state, respectively and selects a task corresponding to the program execution state that has a smallest total number as the next task.

16. The device according to claim 14, wherein
the section characteristic value indicates memory usage in the section corresponding to the section characteristic value, and
the task execution unit calculates a total memory usage for each program execution state, respectively and selects a task corresponding to the program execution state that has a smallest total memory usage as the next task.

17. The device according to claim 14, wherein
the task execution unit has two or more execution units to execute tasks,
the section characteristic value indicates a power consumption of the section corresponding to the section characteristic value,
the program execution state calculator calculates, for each of the tasks not being executed, the program execution state including current sections of tasks being executed and a section to be started when the task not being executed is executed next, and
the task execution unit calculates a total power consumption for each program execution state, respectively and selects a task corresponding to the program execution state having a smallest total power consumption as the next task.

18. A multitask processing device for processing a plurality of tasks, each task being split into at least two sections, comprising:
a stable set storage configured to store a stable set that includes one or more sets each including a section combination and a state of a shared resource;
a program execution state calculator configured to
calculate, for each selected task selected from the tasks, respectively, a program execution state including
a section of the selected task where execution is to start when the selected task is next executed and
current sections of other tasks different from the selected task among the tasks and
specify a state of a shared resource used at each calculated program execution state, respectively
a distance calculating unit configured to calculate a distance between a set including the calculated program execution state and the state of the shared resource corresponding to the calculated program execution state and the stable set, for each calculated program execution state, respectively; and
a task execution unit configured to select and execute a next task to be executed next based on calculated distances.

19. A multitask processing device for processing a plurality of tasks, each task being split into at least two sections, comprising:
a stable set storage configured to store a stable set that includes one or more sets each including a section and a state of at least one of shared resource;
a program execution state calculator configured to
calculate, for each selected task selected from the tasks, respectively, a program execution state including
a section of the selected task where execution is to start when the selected task is next executed and
current sections of other tasks different from the selected task among the tasks and
specify a state of at least one of shared resource used at each calculated program execution state, respectively
combine each section of the calculated program execution state with a specified state corresponding to the calculated program execution state to generate sets each including one section and the specified state, for each calculated program execution state, respectively;
a distance calculating unit configured to calculate a distance from the stable set based on a match number between generated sets corresponding to the calculated program execution state and the stable set, for each calculated program execution state, respectively; and
a task execution unit configured to select and execute a next task to be executed next based on calculated distances.

20. A multitask processing device for processing a plurality of tasks, each task being split into at least two sections, comprising:
a stable set storage configured to store a stable set that includes one or more sets each including a section and a state of a shared resource;
a program execution state calculator configured to
calculate, for each selected task selected from the tasks, respectively, a program execution state including
a section of the selected task where execution is to start when the selected task is next executed and
current sections of other tasks different from the selected task among the tasks and
specify states of one or more shared resources used at each section of the calculated program execution state for each calculated program execution state, respectively
combine each section of the calculated program execution state with each of one or more specified states corresponding to said each section to generate sets each including one section and one specified state, for each calculated program execution state, respectively;
a distance calculating unit configured to calculate a distance from the stable set based on a match number between generated sets corresponding to the calculated program execution state and the stable set, for each calculated program execution state, respectively; and
a task execution unit configured to select and execute a next task to be executed next based on calculated distances.

21. A multitask processing device for processing a plurality of tasks, each task being split into at least two sections, comprising:
a stable set storage configured to store a stable set that includes one or more sets each including a section and a state of at least one of a shared resource;
a program execution state calculator configured to
calculate, for each selected task selected from the tasks, respectively, a program execution state including
a section of the selected task where execution is to start when the selected task is next executed and
current sections of other tasks different from the selected task among the tasks and
specify states of shared resources used at each section of the calculated program execution state for each calculated program execution state, respectively
combine each section of the calculated program execution state with one or more specified states corresponding to said each section to generate sets each including one section and one or more specified states, for each calculated program execution state, respectively;
a distance calculating unit configured to calculate a distance from the stable set based on a match number between generated sets corresponding to the calculated program execution state and the stable set, for each calculated program execution state, respectively; and
a task execution unit configured to select and execute a next task to be executed next based on calculated distances.

22. The device according to claim 18, wherein
the stable set in the stable set storage is based on sections of a plurality of tasks and shared resources used by the tasks when the tasks are properly executed for test cases given in advance by multitask.

23. The device according to claim 19, wherein
the stable set in the stable set storage is based on sections of a plurality of tasks and shared resources used by the tasks when the tasks are properly executed for test cases given in advance by multitask.

24. The device according to claim 20, wherein
the stable set in the stable set storage is based on sections of a plurality of tasks and shared resources used by the tasks when the tasks are properly executed for test cases given in advance by multitask.

25. The device according to claim 21, wherein
the stable set in the stable set storage is based on sections of a plurality of tasks and shared resources used by the tasks when the tasks are properly executed for test cases given in advance by multitask.

26. The device according to claim 18, wherein
the stable set in the stable set storage satisfies likely invariant concerning sections and shared resources, the likely invariant being obtained by executing a plurality of tasks by multitask for test cases given in advance.

27. The device according to claim 19, wherein
the stable set in the stable set storage satisfies likely invariant concerning sections and shared resources, the likely invariant being obtained by executing a plurality of tasks by multitask for test cases given in advance.

28. The device according to claim 20, wherein
the stable set in the stable set storage satisfies likely invariant concerning sections and shared resources, the likely invariant being obtained by executing a plurality of tasks by multitask for test cases given in advance.

29. The device according to claim 21, wherein
the stable set in the stable set storage satisfies likely invariant concerning sections and shared resources, the likely invariant being obtained by executing a plurality of tasks by multitask for test cases given in advance.

30. A multitask processing method for processing a plurality of tasks, each task being split into at least two sections, comprising:
calculating, for each selected task selected from the tasks, respectively, a program execution state including
a section of the selected task where execution is to start when the selected task is next executed and
current sections of other tasks different from the selected task among the tasks;
calculating distances between the program execution states and a stable set including one or more section combinations; and
selecting and executing a next task to be executed next based on calculated distances.

31. A multitask processing method for processing a plurality of tasks, each task being split into at least two sections, comprising:
providing a storage configured to store section characteristic values corresponding to sections;
calculating, for each selected task selected from the tasks, respectively, a program execution state including
a section of the selected task where execution is to start when the selected task is next executed and
current sections of other tasks different from the selected task among the tasks; and
selecting and executing a next task to be executed next based on the section characteristic values of the sections included in each program execution state.
